(19) United States
(12) Patent Application Publication
(10) Pub. No.: US 2009/0298004 A1
(43) Pub. Date: Dec. 3, 2009

(54) TUNNELLING PROBE

(76) Inventor: Ioana M. RIZOIU, San Clemente, CA (US)

Correspondence Address: STOUT, UXA, BUYAN & MULLINS LLP, 4 VENTURE, SUITE 300, IRVINE, CA, 92618, US

(21) Appl. No.: 12/426,940

(22) Filed: Apr. 20, 2009

Related U.S. Application Data
(63) Continuation-in-part of application No. 12/234,593, filed on Sep. 19, 2008.
Application No. 12/234,593 is a continuation-in-part of application No. 10/667,921, filed on Sep. 22, 2003.
Application No. 10/667,921 is a continuation of application No. 09/714,479, filed on Nov. 15, 2000, now Pat. No. 6,669,685.
Application No. 09/714,479 is a continuation-in-part of application No. 09/188,072, filed on Nov. 6, 1998, now Pat. No. 6,254,597.
(60) Provisional application No. 61/046,394, filed on Apr. 18, 2008.
(60) Provisional application No. 60/995,759, filed on Sep. 28, 2007.
(60) Provisional application No. 60/994,891, filed on Sep. 21, 2007.
(60) Provisional application No. 60/994,723, filed on Sep. 20, 2007.
(60) Provisional application No. 60/994,571, filed on Sep. 19, 2007.
(60) Provisional application No. 60/064,465, filed on Nov. 6, 1997.

(51) Int. Cl. A61C 3/00

(52) U.S. Cl. 433/29

(57) ABSTRACT

An electromagnetically induced cutting mechanism provides accurate cutting operations on soft tissues. The electromagnetically induced cutter is adapted to interact with atomized fluid particles. A tissue remover comprises an aspiration cannula housing a fluid and energy guide for conducting electromagnetically induced cutting forces to the site within a patient's body for aspiration of soft tissue. An endodontic probe is used to perform disinfection procedures on target tissues within root canal passages and tubules. The endodontic probe can include an electromagnetic radiation emitting fiber optic tip having a distal end and a radiation emitting region disposed proximally of the distal end. According to one aspect, the endodontic probe can include a porous structure that encompasses a region of the fiber optic tip excluding the radiation emitting region and that is loaded with biologically-active particles, cleaning particles, biologically-active agents, or cleaning agents for delivery from the porous structure onto the target tissues. Another aspect can include provision of the endodontic probe with an adjustable channel-depth indicator, which encompasses a region of the fiber optic tip besides the radiation emitting region and which is movable in proximal and distal directions along a surface of the fiber optic tip to facilitate the provision of depth-of-insertion information to users of the endodontic probe.

### PRIORITY INFORMATION

This application claims the benefit of U.S. Provisional Application 61/046,394, filed Apr. 18, 2008. This application is a continuation-in-part of co-pending U.S. application Ser. No. 12/234,593, filed Sep. 19, 2008 and entitled PROBES AND BIOFLUIDS FOR TREATING AND REMOVING DEPOSITS FROM TISSUE SURFACES (Docket. BI8053P), which is commonly assigned and the contents of which are expressly incorporated herein by reference. U.S. application Ser. No. 12/234,593 claims the benefit of Prov. App. 60/995,759, filed on Sep. 28, 2007 (Docket BI8053PR), Prov. App. 60/994,891, filed on Sep. 21, 2007 (Docket BI8052PR), Prov. App. 60/994,723, filed on Sep. 20, 2007 (Docket BI8051PR), and Prov. App. 60/994,571, filed on Sep. 19, 2007 (Docket BI8050PR), the contents of all which are expressly incorporated herein by reference. This application is a continuation-in-part of co-pending U.S. application Ser. No. 10/667,921, filed Sep. 22, 2003 (Docket. BI9100CIPCON), which is commonly assigned and the contents of which are expressly incorporated herein by reference. U.S. application Ser. No. 10/667,921 is a continuation of U.S. application Ser. No. 09/714,479, filed Nov. 15, 2000 (now U.S. Pat. No. 6,669,685). U.S. application Ser. No. 09/714,479 is a continuation-in-part of U.S. application Ser. No. 09/188,072, filed Nov. 6, 1998 (now U.S. Pat. No. 6,254,597), the contents of which are expressly incorporated herein by reference. U.S. application Ser. No. 09/188,072 claims the benefit of, and incorporates by reference the contents of, U.S. Provisional Application No. 60/064,465, filed Nov. 6, 1997.

### BACKGROUND OF THE INVENTION

1. Field of the Invention

The present invention relates generally to electromagnetic radiation procedural devices and, more particularly, to the use of electromagnetic radiation devices in medical applications.

2. Description of Related Art

A primary causative agent in pulpal and periapical pathosis is inadequate bacteria control. Research has shown that the absence of infection before obturation of a tooth undergoing endodontic treatment can result in a higher success rate, thus indicating the control or elimination of such intracanal pathogens to be advantageous to the generation of a favorable outcome for a given procedure.

The prior art has encompassed various endodontic treatments directed to the attenuation of bacterial counts and adverse symptoms from the root canal system, many being implemented in a relatively nonsurgical or low impact fashion. Typically, clinical endodontic procedures have relied on mechanical instrumentation, mechanical intracanal irrigants, and medicaments to disinfect the root canal system.

Prior-art instrumentation techniques involving hand and/or rotary instruments, as well as ultrasonic and sonic devices, have brought about some success in reducing bacterial loads in infected canals. While such instrumentation techniques of the prior art have not been altogether ineffective, they do tend to fall short of the goal of total or near total disinfection of the root canal system.

In the category of irrigants, agents such as sodium hypochlorite and chlorhexidine have been implemented in root canal disinfecting treatments with some degree of success. Such agents have been found to be capable, for example, of providing relatively useful antimicrobial effects in certain instances. Here, too, infection of the root canal and adjacent dentin may persist, however, following such applications, owing perhaps to an inability of these agents to reach all the infecting microorganisms.

Regarding the third mentioned category, of medicaments, the use of intracanal medications, such as calcium hydroxide, has typically been ineffective in the context of short-term applications. That is, longer term applications have frequently been indicated as a consequence, for example, of such agents failing to adequately address and eliminate endodontic infections by way of only a few applications. Consequently, such applications in the prior-art have typically required multiple applications, which in turn have required multiple patient visits. These multiple visits, while potentially increasing a rate of effective treatments in connection with medicaments such as calcium hydroxide, can increase treatment time and reduce patient compliance, thus increasing the risk of treatment failure.

Lasers, such as mid-infrared lasers including the Erbium, chromium:yttrium-scandiumgallium-garnet (Er,Cr:YSGG) laser, have been used in root canal procedures involving cleaning, shaping and enlarging of the root canal, as well as in osseous, apical and periodontal surgical procedures. The Er,Cr:YSGG laser is known to be capable of removing calcified hard tissues by emitting a beam of infrared energy at 2.78 μm in combination with an emitted water spray.

Turning to FIG. 1, a prior art optical cutter includes a fiber guide tube 5, a water line 7, an air line 9, and an air knife line 11 for supplying pressurized air. A cap 15 fits onto the hand-held apparatus 13 and is secured via threads 17. The fiber guide tube 5 abuts within a cylindrical metal piece 19. Another cylindrical metal piece 21 is a part of the cap 15. The pressurized air from the air knife line 11 surrounds and cools the laser as the laser bridges the gap between the two metal cylindrical objects 19 and 21. Air from the air knife line 11 flows out of the two exhausts 25 and 27 after cooling the interface between elements 19 and 21.

The laser energy exits from the fiber guide tube 23 and is applied to a target surface of the patient. Water from the water line 7 and pressurized air from the air line 9 are forced into the mixing chamber 29. The air and water mixture is very turbulent in the mixing chamber 29, and exits this chamber through a mesh screen with small holes 31. The air and water mixture travels along the outside of the fiber guide tube 23, and then leaves the tube and contacts the area of surgery.

Other prior art devices include optical cutting systems utilizing the expansion of water to destroy and remove tooth material, such as disclosed in U.S. Pat. No. 5,199,870 to Steiner et al. This prior art approach requires a film of liquid having a thickness of between 10 and 200 μm. U.S. Pat. No. 5,267,856 to Wolbarsht et al. discloses a cutting apparatus that requires water to be inserted into pores of a material and then irradiated with laser energy. In both patents the precision and accuracy of the cut is highly dependent upon the precision and accuracy of the water film on the material or the water within the pores.

Devices have existed in the prior art for utilizing laser energy to perform liposuction and body contouring procedures, wherein laser energy facilitates the separating of soft tissue from a patient in vivo. U.S. Pat. No. 4,985,027 to Dressel discloses a tissue remover that utilizes laser energy from a Nd:YAG to separate tissue held within a cannula, the contents of which are expressly incorporated herein by reference. Use of the Nd:YAG laser for in vivo tissue removal is in some ways inefficient, since the energy from the Nd:YAG laser is not highly absorbed by water. Further, the Nd:YAG laser and other lasers, such as an Er:YAG laser, use thermal heating as the cutting mechanism. Adjacent tissue can be charred or thermally damaged and, further, noxious and potentially toxic smoke can be generated during the thermal cutting operations performed by these prior-art devices.

Devices also have existed in the prior art for performing endoscopic surgical procedures, wherein one or more catheters or cannulas are inserted through a small opening in a patient's skin to provide various working passageways through which small surgical instruments can be advanced into the patient during surgery. Specific endoscopic applications include arthroscopic surgery, neuroendoscopic surgery, laparoscopic surgery, and liposuction. Arthroscopic surgery refers to surgery related to, for example, joints such as the shoulders and knees. One prior-art device, which has been used during the implementation of an arthroscopic surgical procedure is an arthroscopic shaver. The arthroscopic shaver entails the application of a spinning tube-within-a-tube that concurrently resects tissue while aspirating debris and saline from within the operative site. One such arthroscopy system is the DYONICS ®. Model EP-1 available from Smith & Nephew Endoscopy, Inc., of Andover, Mass. Cutting with such an instrument is obtained by driving the inner tube at a high speed using a motor. Surrounding the tubular blade is an outer tubular membrane having a hub at its proximal end adapted to meet with the handle. Performing an arthroscopic procedure with a high-speed rotary shaver such as the one mentioned above may result in extensive trauma to the tissue and blood vessel laceration.

### SUMMARY OF THE INVENTION

The present invention discloses an electromagnetically induced cutting mechanism, which can provide accurate cutting operations on hard and soft tissues, and other materials as well. Soft tissues may include fat, skin, mucosa, gingiva, muscle, heart, liver, kidney, brain, eye, and vessels, and hard tissue may include tooth enamel, tooth dentin, tooth cementum, tooth decay, amalgam, composites materials, tarter and calculus, bone and cartilage.

A laser having a high absorption for one or more predetermined fluids, which are disposed either around or adjacent to a target tissue or disposed within the target tissue, is implemented to achieve intra-passage or intracanal disinfection. The fluid can comprise water in typical applications, and the target tissue can comprise soft tissue such as that of a root canal wall in exemplary implementations of the invention. The laser can be operated to clean or disinfect tissue within the root canal in one mode in which an external source applies fluid to or in a vicinity of the target tissue or in another mode in which external fluid is not applied, the latter mode being capable of potentiating an effect of absorption of the laser energy or greater absorption of the laser energy by fluids within bacteria on or in the target tissue. In accordance with another feature of the present invention, radially emitting laser tips are used in the implementation of cleaning and disinfecting procedures of root canals. The radially emitting or side firing effects provided by these laser tips can facilitate, among other things, better coverage of the root canal walls in certain instances as compared, for example, to conventional, forward firing tips. Consequently, a probability that the emitted laser energy will enter dentinal tubules of the root canal can be augmented, thus increasing a disinfecting potential or efficacy of the system, whereby disinfection or cleaning of portions of dentinal tubules disposed at relatively large distances from the canal can be achieved or achieved more efficiently (e.g., during a smaller time window) or more reliably (e.g., yielding results with greater reproducibility).

According to one aspect of the present invention, an endodontic probe is used to perform disinfection of target tissues within root canal passages and tubules. The endodontic probe can comprise an electromagnetic radiation emitting fiber optic tip having a distal end and a radiation emitting region disposed proximally of the distal end, and can further comprise a porous structure which encompasses a region of the fiber optic tip excluding the radiation emitting region and/or which comprises a material that is transparent to a wavelength of energy carried by the electromagnetic radiation emitting fiber optic tip. The porous structure can be loaded with biologically-active particles, cleaning particles, biologically-active agents, and/or cleaning agents that are structured to be delivered from the porous structure onto the target tissues.

Another feature of the present invention includes an endodontic probe for performing disinfection of target tissues within root canal passages and tubules, the endodontic probe comprising (a) an electromagnetic radiation emitting fiber optic tip having a distal end and a radiation emitting region disposed proximally of the distal end and (b) an adjustable channel-depth indicator encompassing a region of the fiber optic tip besides the radiation emitting region. The adjustable channel-depth indicator can be configured to be movable in proximal and distal directions along a surface of the fiber optic tip to provide, for example, depth-of-insertion information to a user of the endodontic probe.

In accordance with the present invention, an electromagnetically induced cutter is used to perform surgical procedures, using cannulas and catheters, also known as endoscopic surgical procedures. Endoscopic surgical applications for the electromagnetic cutter of the present invention include arthroscopic surgery, neuroendoscopic surgery, laparoscopic surgery, liposuction and other endoscopic surgical procedures. The electromagnetically induced cutter is suitable to be used for arthroscopic surgical procedures in the treatment of, for example: (i) torn menisci, anterior cruciate, posterior cruciate, patella malalignment, synovial diseases, loose bodies, osteal defects, osteophytes, and damaged articular cartilage (chondromalacia) of the knee; (ii) synovial disorders, labial tears, loose bodies, rotator cuff tears, anterior impingement and degenerative joint disease of the acromioclavicular joint and diseased articular cartilage of the shoulder joint; (iii) synovial disorders, loose bodies, osteophytes, and diseased articular cartilage of the elbow joint; (iv) synovial disorder, loose bodies, ligament tears and diseased articular cartilage of the wrist; (v) synovial disorders, loose bodies, labrum tears and diseased articular cartilage in the hip; and (vi) synovial disorders, loose bodies, osteophytes, fractures, and diseased articular cartilage in the ankle.

The electromagnetically induced cutter of the present invention is disposed within a cannula or catheter and positioned therein near the surgical site where the treatment is to be performed. In accordance one aspect of the present invention, a diameter of the cannula or catheter is minimized to reduce the overall cross-sectional area of the cannula or catheter for the performance of minimally invasive procedures. In accordance with another aspect of the present invention, a plurality of catheters is formed together for various purposes. For example, in arthroscopic knee surgery, one cannula is configured to incorporate the cutting device and suction, and a separate cannula is configured to incorporate the imaging system that monitors the treatment site during the procedure. In accordance with yet another aspect of the present invention, the suction, cutting device and imaging device are all incorporated within the same cannula. Another aspect of the present invention provides for an additional third cannula for supplying air to the treatment site.

The electromagnetically induced cutter of the present invention is capable of providing extremely fine and smooth incisions, irrespective of the cutting surface. Additionally, a user programmable combination of atomized particles allows for user control of various cutting parameters. The various cutting parameters may also be controlled by changing spray nozzles and electromagnetic energy source parameters. Applications for the present invention include medical, such as arthroscopic surgery, neuroendoscopic surgery, laparoscopic surgery, liposuction and dental, and other environments where an objective is to precisely remove surface materials without inducing thermal damage, uncontrolled cutting parameters, and/or rough surfaces inappropriate for ideal bonding. The present invention further does not require any films of water or any particularly porous surfaces to obtain very accurate and controlled cutting. Since thermal heating is not used as the cutting mechanism, thermal damage does not occur. Adjacent tissue is not charred or thermally damaged and, further, noxious and potentially toxic smoke is attenuated or completely eliminated.

The electromagnetically induced cutter of the present invention includes an electromagnetic energy source, which focuses electromagnetic energy into a volume of air adjacent to a target surface. The target surface may comprise fatty tissue within a cannula, for example. A user input device specifies a type of cut to be performed, and an atomizer responsive to the user input device places a combination of atomized fluid particles into the volume of air. The electromagnetic energy is focused into the volume of air, and the wavelength of the electromagnetic energy is selected to be substantially absorbed by the atomized fluid particles in the volume of air. Upon absorption of the electromagnetic energy the atomized fluid particles expand and impart cutting forces onto the target surface.

The electromagnetically induced cutter of the present invention can provide an improvement over prior-art high-speed rotary shavers, such as the above-mentioned arthroscopic shaver, since the electromagnetically induced cutter of the present invention does not directly contact the tissue to cause trauma and blood vessel laceration. Instead, cutting forces remove small portions of the tissue through a process of fine or gross erosion depending on the precision required. This process can be applied to precisely and cleanly shave, reshape, cut through or remove cartilage, fibrous cartilage, or bone without the heat, vibration, and pressure associated with rotary shaving instruments. The system can be used without air and/or water, in order to coagulate bleeding tissue. In accordance with another application of the electromagnetic cutter, a spray of water is the carrier of an anti-coagulant medication that could also contribute to tissue coagulation.

Other endoscopic applications for the electromagnetically induced mechanical cutter include neurosurgical and abdominal surgical applications. In neurosurgery, the electromagnetically induced mechanical cutter is suited for removing brain tissue lesions, as well as for the cutting of various layers of tissue to reach the locations of the lesions. The entire method of creating an access through the scalp into the bone and through the various layers of tissue that protect the brain tissue can be accomplished with the electromagnetically induced mechanical cutter of the present invention.

The invention, together with additional features and advantages thereof may best be understood by reference to the following description taken in connection with the accompanying illustrative drawings.

### BRIEF DESCRIPTION OF THE DRAWINGS

FIG. 1 is a conventional optical cutter apparatus;

FIG. 2 is a schematic block diagram illustrating the electromagnetically induced cutter of the present invention;

FIG. 3 illustrates one embodiment of the electromagnetically induced cutter of the present invention;

FIGS. 4a and 4b illustrate a preferred embodiment of the electromagnetically induced cutter;

FIG. 5 illustrates a control panel for programming the combination of atomized fluid particles according to the present invention;

FIG. 6 is a plot of particle size versus fluid pressure;

FIG. 7 is a plot of particle velocity versus fluid pressure;

FIG. 8 is a schematic diagram illustrating a fluid particle, a source of electromagnetic energy, and a target surface according to the present invention;

FIG. 9a is a side cut-away elevation view of a preferred tissue remover of the present invention with a cannula tip;

FIG. 9b is a side cut-away elevation view of a preferred tissue remover of the present invention with an open cannula end;

FIG. 10a is an exploded longitudinal section view of the distal end of the cannula with a cannula tip;

FIG. 10b is an exploded longitudinal section view of the distal end of the cannula with an open cannula end;

FIG. 11a is an exploded view similar to FIG. 10a, showing an electromagnetically induced cutter disposed adjacent the soft tissue aspiration inlet port;

FIG. 11b is an exploded view similar to FIG. 10b, showing an electromagnetically induced cutter disposed within the cannula;

FIG. 11c is a block diagram illustrating an imaging tube and imaging device disposed within the cannula;

FIG. 12 is a partial exploded longitudinal section view of the handle and proximal end cap showing the laser fiber and sources of fluids within the fluid and laser guide tube;

FIG. 13 is a partial exploded longitudinal section of a guide tube transmission coupler positioned within the handle; and

FIGS. 14-25 are longitudinal section views of the distal end of the cannula with an open cannula end according to additional embodiments of the present invention.

### DESCRIPTION OF THE PRESENTLY PREFERRED EMBODIMENTS

Reference will now be made to certain embodiments (e.g., certain illustrated embodiments) of the invention, examples of which are illustrated in the accompanying drawings. Wherever possible, the same or similar reference numbers are used in the drawings and the description to refer to the same or like parts. It should be noted that the drawings are in simplified form and are not presumed, automatically, to be to precise scale in all embodiments. That is, they are intended to be examples of implementations of various aspects of the present invention and, according to certain but not all embodiments, to be to-scale. While, according to certain implementations, the structures depicted in these figures are to be interpreted to be to scale, in other implementations the same structures should not. In certain aspects of the invention, use of the same reference designator numbers in the drawings and the following description is intended to refer to similar or analogous, but not necessarily the same, components and elements. According to other aspects, use of the same reference designator numbers in these drawings and the following description is intended to be interpreted as referring to the same or substantially the same, and/or functionally the same, components and elements. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain embodiments (e.g., certain illustrated embodiments), it is to be understood that these embodiments are presented by way of example and not by way of limitation. The intent accompanying this disclosure is to discuss exemplary embodiments with the following detailed description being construed to cover all modifications, alternatives, and equivalents of the embodiments as may fall within the spirit and scope of the invention as defined by the additional disclosure in claims format. It is to be understood and appreciated that the process steps and structures described herein do not cover a complete architecture or process, and only so much of the commonly practiced features and steps are included herein as are necessary to provide an understanding of the present invention. The present invention has applicability in the field of laser devices in general. For illustrative purposes, however, the following description pertains to a medical laser device and a method of operating the medical laser device to perform surgical functions.

The following illustrations represent conceptual prototypes of sponge/sheath dispensing mechanisms according to the present invention, which mechanisms can be used to hold and position components (e.g., fluids), or components/agents as defined below, in proximity to an output fiber optic tip, or a probe, for dispensing, for example, of the components (e.g., biofluids or biopowders, as disclosed herein) or components/agents during a procedure such as a treatment procedure on tissue. The sponges and sheaths can be formed, for example, in a compact (e.g., low profile) fashion for providing minimally invasive access to the surgical site of tissue (e.g., a canal, pocket, such as a periodontal pocket, or other formation of tissue).

The sponges can be formed, for example, according to process steps and/or structures as implemented, in whole or in part, in products elucidated and/or referenced in connection with the “K-Sponge” name or brand, such as owned by Katena Products, Inc., of Denville, N.J., the entire set of products and relevant contents of which is incorporated herein by reference.

Components, such as one or more of the fluids, biofluids and biopowders disclosed herein, and/or any sub-components or agents thereof (“components/agents”), may be applied to the sponge in one or more of a powder, liquid and/or intermediate (e.g., gel or part powder/liquid) state, for subsequent release on or near a treatment site. The components/agents may be added in liquid or semi-liquid form before the sponge is formed into a compressed or low-profile shape (using, for example, any one or more parts of the above-referenced K-Sponge technology), followed by, for example, drying (e.g., dehydrating) and compressing of the sponge.

Alternatively, and/or additionally, components/agents may be added in a powder, solid, semi-solid, suspended solid, dissolved or distributed solid, gel and/or powder/liquid form before, during and/or after the sponge is formed into a compressed or low-profile shape (using, for example, any one or more parts of the above-referenced K-Sponge technology). In an implementation wherein one or more components/agents are added after the sponge has been formed into a compressed or low-profile shape, the sponge may be contacted with the component(s)/agent(s) by way of (1) dipping of the sponge into a component/agent containing solution, (2) dripping of a liquid containing the component/agent onto the sponge, or touching of the sponge with a powder of or containing the component/agent so that the component/agent attaches to a surface of and/or an interior of the sponge.

The sponges may take various shapes to be effective. These shapes can be, but are not limited to rectangular, point-end, and round-end shapes. Once placed into contact with, for example, fluid in the mouth, the sponge can be configured to expand and allow the release of biofluids or biopowders to the target site to aid the procedure.

The sheaths can be formed, for example, of a silicon type sheet of material. In other embodiments, the sheaths may be formed, in whole or in part, of, for example, gelatin and/or cellulose (e.g., alpha-cellulose). Moreover, the sheaths of the present invention may alternatively or additionally be formed, in whole or in part, of any one or more of the materials, structures, compositions or distributions of compositions, shapes, components/agents and/or steps used to make/use the sponges as described or referenced herein.

The architecture of each sheath may comprise, for example: (a) a construction with one or more pores or perforations disposed anywhere along a length thereof and/or (b) a construction without pores and an opening at a distal end thereof. Either or both of the (a) and (b) constructions can be configured for dispensing the components/agents (e.g., biofluids, biopowders and/or other material) as, for example, described and depicted herein. Once pressed into contact with, for example, tissue, the sheath may release biofluids or biopowders to the target site to aid the procedure.

Furthermore, components/agents may be disposed (e.g., selectively disposed) on or in only parts of the sponge or sheath, such as on and/or in one or more of: selected (e.g., partial) area(s), selected volume(s), a single side, selected pores, other surface features or indentations, all pores or other surface features or indentations, and combinations thereof.

Combination embodiments comprising hybrid sponge/sheath implementations, such as a sheath made of a sponge-like material, may also be implemented. As another example of a modification, rather than or in addition to a sponge or a sheath of sponge-like material, and/or in any embodiment described herein, an external surface of the sponge and/or sheath can be formed with surface irregularities (e.g., features) to hold components/agents (e.g., biofluids or biopowders), such as, for example, bristles.

Another application for the same sponge and/or sheath (without biofluids or biopowders) is the use of removing material from the tissue site. The sponge and/or sheath can absorb and collect dislodged materials (e.g., calculus deposits and/or removed tissue, dislodged or removed by way of, for example, the probe, fiber, other implement to which the sponge is affixed) from the site instead of using suction or other methods of removing the debris from the target.

Any of the implementations described or referenced herein may be loaded with a component/agent (e.g., biofluid or biopowder) that, for example, (1) softens a component or agent on a surface of the target (e.g., a calculus deposit, and/or with such softening agent being, e.g., propylene glycol alginate (PGA)—whereby, for example, EMD dissolves in PGA at acidic pH (and/or, for example, a laser may be used to dehydrate tissue surface in order to facilitate the deposition of the EMD product)); (2) cleans the target (e.g., root) surface (e.g., an acidic component and/or etching agent, e.g., EDTA); and/or (3) medicaments such as anesthetizing agents, growth promoters, etc.

Other embodiments can be fiber bundles with non cylindrical (e.g., non truncated) distal ends (e.g., angled, beveled, double-beveled, etc. distal ends) to provide different energy outputs with varying characteristics. For such bundled embodiments one or more components/agents (e.g., a viscous component(s)) may be disposed in one or more of a central area or lumen and a peripheral area(s) of the optical fibers, and/or may be disposed or dispersed between two or more of the optical fibers. The cross-section can be a circular cross-sectional area wherein the body of each fiber bundle resemble an envelope (i.e., shape) of a cylinder, and/or other cross-sectional shapes are also possible, such as rectangular shape or other shapes.

In other embodiments, the cross-sections may correspond to flat or blade configurations of fiber bundles. Thus, as an example of a “thin blade” fiber bundle configuration, a cross section may comprise a single, straight (or, alternatively, arched) row formed by five circles (i.e., “ooooo”) corresponding to a fiber bundle formed of five fiber optics and having a flat (or, alternatively, arched) cross-sectional shape (rather than the illustrated circular cross-sectional shape). As another example, which may be used as an alternative to the mentioned “thin blade” fiber bundle, a “double-thickness blade” construction may include a fiber bundle configuration, a cross section of which comprises a single, straight (or, alternatively, arched) row formed by two rows of five circles (i.e., “ooooo”) each corresponding to a fiber bundle formed to be five fiber optics wide and two fiber optics thick and having a flat (or, alternatively, arched) cross-sectional shape (rather than the illustrated circular cross-sectional shape). As another example, a “triple-thickness blade” construction may include a fiber bundle configuration, a cross section of which comprises a single, straight (or, alternatively, arched) row formed by three rows of five circles (i.e., “ooooo”) each corresponding to a fiber bundle formed to be five fiber optics wide and three fiber optics thick and having a flat (or, alternatively, arched) cross-sectional shape.

Rather than the number of “five” (or other number of) fiber optics, other implementations may comprise other numbers such as ten, fifteen, twenty, or more fiber optics. Additionally, as another alternative to the number of “five” (or other number of) fiber optics, other implementations may comprise a continuous compartment. The light transmitting centers or compartments (e.g., of the fiber optic or continuous compartment) may be hollow or solid, and may be bordered by one or more of a skin, jacket or outer wall (e.g., reflective or, alternatively, transmissive to a wavelength or the wavelength of radiation).

In still other embodiments, the cross-sections may correspond to oval or circular configurations of fiber bundles. As an example, a cross section may comprise a single, closed row formed by about six circles (i.e., “oooooo”) corresponding to a fiber bundle formed of six fiber optics and having an oval or circular cross-sectional shape. Other examples may comprise any fewer or, typically, greater number of circles, such as ten, twenty, or more. Other examples, which may be used as an alternative to any mentioned single-row implementation of an oval or circular shape, can comprise, for example, a double-row or triple-row of fiber optics (“oooooo”) each corresponding to a fiber bundle formed to be six fiber optics wide and two, or three, fiber optics thick.

Additionally, as an alternative to the mentioned “six” (or other number of) fiber optics, other implementations may comprise a continuous compartment such as that symbolized, for example, by “====” rather than “oooooo” (e.g., the equivalent of an infinite number of fiber optics, or an interior formed between two planar, e.g., straight or arched, surfaces). The light transmitting centers or compartments (e.g., of the fiber optic or continuous compartment) may be hollow or solid, and may be bordered by one or more of a skin, jacket or outer wall (e.g., reflective or, alternatively, transmissive to a wavelength or the wavelength of radiation). For instance, a structure defining the prophy cup may be transparent to a wavelength(s) of radiation (e.g., laser or LLLT energy) emitted from the device. The light transmitting centers or compartments may be hollow or solid.

According to certain implementations, the skin, jacket or outer wall may comprise a construction and/or may comprise (e.g., consist of) a sponge or sheath as described herein. In one implementation, the light-transmitting center is bordered with a sponge or sheath (e.g., a wall or a membrane that is: flexible, rigid, fabric, removable, permanently attached, porous, perforated, nonporous, nonperforated, and/or of the same or different material as the tip) over one of its two planar/arched boundaries.

In another implementation, the light-transmitting center is bordered with a sponge or sheath (e.g., a wall or a membrane that is: flexible, rigid, fabric, removable, permanently attached, porous, perforated, nonporous, nonperforated, and/or of the same or different material as the tip) over both of its planar/arched boundaries. In yet another implementation, all or substantially all of the light-transmitting center is surrounded with sponge or sheath (e.g., a wall or membrane that is: flexible, rigid, fabric, removable, permanently attached, porous, perforated, nonporous, nonperforated, and/or of the same or different material as the tip). The wall(s) or membrane(s) may correspond to a shape encompassing part or all of any fiber optic described or referenced herein. Furthermore, the wall(s) or membrane(s) may comprise, take the form, resemble, or serve as a prophy cup.

Additionally, any of the compartments may comprise structure for carrying any type of fluid described or referenced herein as an alternative to or in addition to a gel or paste. The “dispensing cannula” language is intended to encompass, or be defined by, one or more of the above mentioned sponges or sheaths, so that, for example, the interior of the cannula may correspond to the above mentioned transmitting centers or compartments. Furthermore, the structures in any number, permutation, or combination, can be interpreted, or formed as, as any one or more of the herein described or referenced optics, tips, fibers, fiber optics, fiber bundles; and/or may have transmitting centers or compartments.

Any one or more of the herein described or referenced optics, tips, fibers, fiber optics, and/or fiber bundles may comprise shapes, surfaces, structures and/or functions as described or referenced in one or more of the documents referenced herein, including, application Ser. No. 11/033,043 filed Jan. 10, 2005 (Docket BI9830P); application Ser. No. 09/714,497 filed Nov. 15, 2000 (Docket BI9100CIP); application Ser. No. 11/800,184 (Docket BI9827CIP2), Int. App. PCT/US08/52106 (Docket BI9827CIPPCT); and application Ser. No. 11/033,441 (Docket BI9827P).

Lumens of any of the structures herein described or referenced may be provided with any one or more of the structures and/or arrangements as disclosed, referenced, or taught by any one or more of the documents referenced herein, including, application Ser. No. 11/033,043 filed Jan. 10, 2005 (Docket BI9830P); application Ser. No. 09/714,497 filed Nov. 15, 2000 (Docket BI9100CIP); application Ser. No. 11/800,184 (Docket BI9827CIP2), Int. App. PCT/US08/52106 (Docket BI19827CIPPCT); and application Ser. No. 11/033,441 (Docket BI9827P). For instance, the area inside of the prophy cup may correspond to the distal end of, for example, any figures of application Ser. No. 11/033,043; or the area inside of the prophy cup may correspond to the distal end of, for example, any of figures of U.S. Pat. No. 5,741,247.

Furthermore, any embodiment described or referenced may comprise one or more of the fiber optics (e.g., of a give fiber bundle) having a shape other than that of a regular, conventional, cylindrically-shaped fiber optic end (i.e., a truncated fiber end corresponding or identical to the shape of a cylinder). For example, one or more of the fiber optics may comprise a planar, beveled output end of any orientation and/or may comprise an output end that may be wholly or partially spherical, rounded, jagged, chiseled or otherwise shaped for altering a light-intensity output distribution thereof, as compared to a truncated fiber end.

Use of side-firing tips can increase the probability that the emitted laser radiation will enter dentinal tubules and have an effect on bacteria (e.g., to attenuate or eliminate endodontic infection) that are some distance from the canal. Distal ends or regions of the fiber output tips (e.g., side-firing tips and/or tips formed of sapphire or quartz) can be formed with jackets or without jackets such as disclosed, for example, in the herein referenced patents and patent applications.

In another implementation, a user can dip the fiber or bundled fiber construction into a component or medicament (e.g., any bioflulid or biopowder as described herein), before use thereof. Any of such constructions may be implemented as a single fiber, as well, as distinguished from a fiber bundle. Also, the “sheath” may be embodied, in addition and/or as an alternative to any of the implementations described herein, as a side cannula; thus, a single or an additional cannula or cannulas can be provided on the side each with a single output at its distal end and/or with one or more output apertures along a length thereof, alone or in addition to, for example, a central cannula-type (e.g., lumen) structure for holding/dispensing components (e.g., biofluids or biopowders) along length thereof.

According to certain implementations, laser radiation is output from a power or treatment fiber (e.g., forming or within a probe), and is directed, for example, into fluid (e.g., an air and/or water spray or an atomized distribution of fluid particles from a water connection and/or a spray connection near an output end of the handpiece) that is emitted from a fluid output of a handpiece above a target surface (e.g., one or more of tooth, bone, cartilage and soft tissue). The fluid output may comprise a plurality of fluid outputs, concentrically arranged around a power fiber, as described in, for example, application Ser. No. 11/042,824 and Prov. App. 60/601,415. The power or treatment fiber may be coupled to an electromagnetic radiation source comprising, for example, one or more of a wavelength within a range from about 2.69 to about 2.80 microns and a wavelength of about 2.94 microns. In certain implementations the power fiber may be coupled to one or more of a diode, an Er:YAG laser, an Er:YSGG laser, an Er, Cr:YSGG laser and a CTE:YAG laser, and in particular instances may be coupled to one of an Er, Cr:YSGG solid state laser having a wavelength of about 2.789 microns and an Er:YAG solid state laser having a wavelength of about 2.940 microns. An apparatus including corresponding structure for directing electromagnetic radiation into an atomized distribution of fluid particles above a target surface is disclosed, for example, in the below-referenced U.S. Pat. No. 5,741,247, which describes the impartation of laser radiation into fluid particles to thereby apply disruptive forces to the target surface.

According to exemplary embodiments, operation in one or more of a gaseous and a liquid environment (e.g., within a channel or canal) can comprise a laser (e.g., an Er, Cr:YSGG solid state laser) having: a repetition rate of about 10 or 20 Hz or, in other implementations (e.g., for one or more of a relatively larger channel and a more calcified or stubborn target) about 30 to 50 Hz; and an energy per pulse from about 2 to 60 mJ, or in other embodiments (e.g., for one or more of a relatively larger channel and a more calcified or stubborn target) greater than 60 mJ such as levels up to about 150 mJ or 200 mJ. The higher frequencies are believed potentially to enhance an efficiency or efficacy of one or more of enlargement and shaping, root canal debridement and cleaning, pulp extirpation, pulpotomy for root canal therapy, sulcular debridement, and others. For exemplary channel transverse-widths (e.g., diameters) greater than 25 microns, such as those ranging from about 250 to 450, or 600, microns, probe or fiber diameters may range from about 10 to 450 microns, or from about 25 to 300 microns.

For channels comprising one or more of a relatively large diameter (e.g., about 400 or 450 to about 600, or more, microns) and a more calcified or stubborn target, probe or fiber diameters may range from about 300 to 400, or 500, or 600, or more, microns. An example may comprise a 200 to 300 micron fiber, outputting radiation at about 60 mJ/pulse and 50 Hz, in a 250 to 600 micron wide canal. Probe or fiber output regions may comprise, for example, one or more of the structures and functions as disclosed in, for example, any of Prov. App. 61/012,446 (Docket BI8063PR), Prov. App. 60/995,759 (Docket BI8053PR), Prov. App. 60/961,113 (Docket BI8038PR), application Ser. No. 11/800,184 (Docket BI9827CIP2), Int. App. PCT/US08/52106 (Docket BI9827CIPPCT), application Ser. No. 11/330,388 (Docket BI9914P), application Ser. No. 11/033,441 (Docket BI9827P), and U.S. Pat. No. 7,270,657 (Docket BI9546P). As an example, the outputting distal end of a probe or fiber may comprise a conical shape having a full angle of about 45 to 60 degrees and/or may comprise one or more beveled surfaces.

By way of the disclosure herein, a laser has been described that can output electromagnetic radiation useful to diagnose, monitor and/or affect a target surface. In the case of procedures using fiber optic tip radiation, a probe can include one or more power or treatment fibers for transmitting treatment radiation to a target surface for treating (e.g., ablating) a dental structure, such as within a canal. In any of the embodiments described herein, the light for illumination and/or diagnostics may be transmitted simultaneously with, or intermittently with or separate from, transmission of the treatment radiation and/or of the fluid from the fluid output or outputs.

FIG. 2 is a block diagram illustrating an electromagnetically induced cutter in accordance with the present invention. An electromagnetic energy source 51 is coupled to both a controller 53 and a delivery system 55. The delivery system 55 imparts forces onto the target surface 57. As presently embodied, the delivery system 55 comprises a fiber optic guide for routing the laser 51 into an interaction zone 59, located above the target surface 57. The delivery system 55 further comprises an atomizer for delivering user-specified combinations of atomized fluid particles into the interaction zone 59. The controller 53 controls various operating parameters of the laser 51, and further controls specific characteristics of the user-specified combination of atomized fluid particles output from the delivery system 55.

FIG. 3 shows a simple embodiment of the electromagnetically induced cutter of the present invention, in which a fiber optic guide 61, an air tube 63, and a water tube 65 are placed within a hand-held housing 67. The water tube 65 is operated under a relatively low pressure, and the air tube 63 is operated under a relatively high pressure. The laser energy from the fiber optic guide 61 focuses onto a combination of air and water, from the air tube 63 and the water tube 65, at the interaction zone 59. Atomized fluid particles in the air and water mixture absorb energy from the laser energy of the fiber optic tube 61, and explode. The explosive forces from these atomized fluid particles impart cutting forces onto the target surface 57.

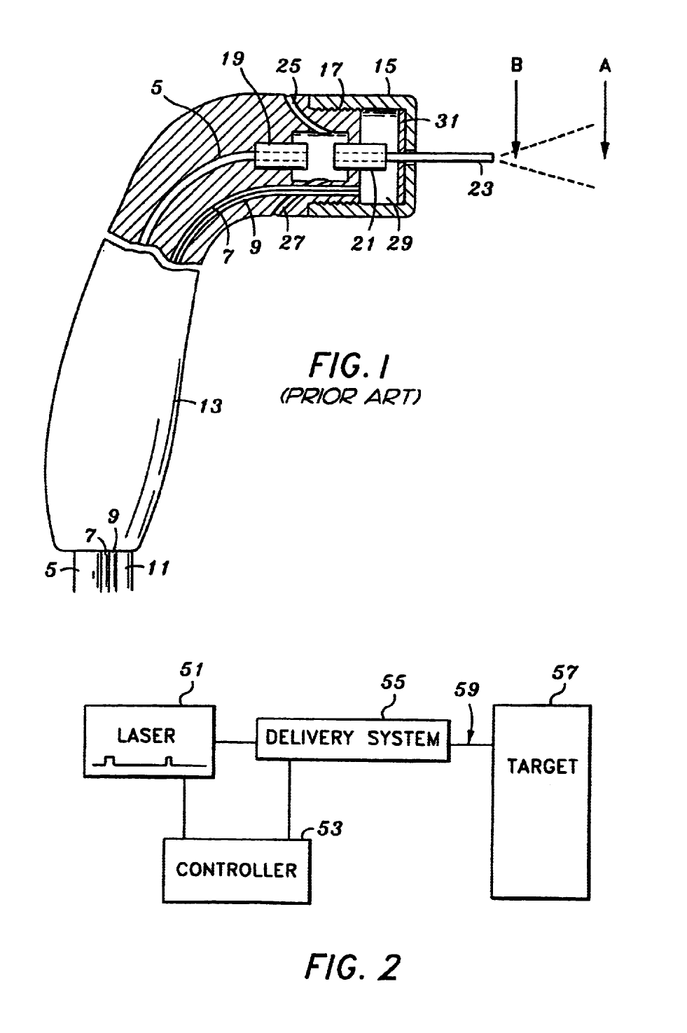

Turning back to FIG. 1, the prior art optical cutter focuses laser energy onto a target surface at an area A, for example, and the electromagnetically induced cutter of the present invention focuses laser energy into an interaction zone B, for example. The prior art optical cutter uses the laser energy directly to cut tissue, and the electromagnetically induced cutter of the present invention uses the laser energy to expand atomized fluid particles to thus impart cutting forces onto the target surface. The prior art optical cutter must use a large amount of laser energy to cut the area of interest, and also must use a large amount of water to both cool this area of interest and remove cut tissue.

In contrast, the electromagnetically induced cutter of the present invention uses a relatively small amount of water and, further, uses only a small amount of laser energy to expand atomized fluid particles generated from the water. According to the electromagnetically induced cutter of the present invention, water is not needed to cool the area of surgery, since the exploded atomized fluid particles are cooled by exothermic reactions before they contact the target surface. Thus, atomized fluid particles of the present invention are heated, expanded, and cooled before contacting the target surface. The electromagnetically induced cutter of the present invention is thus capable of cutting without charring or discoloration.

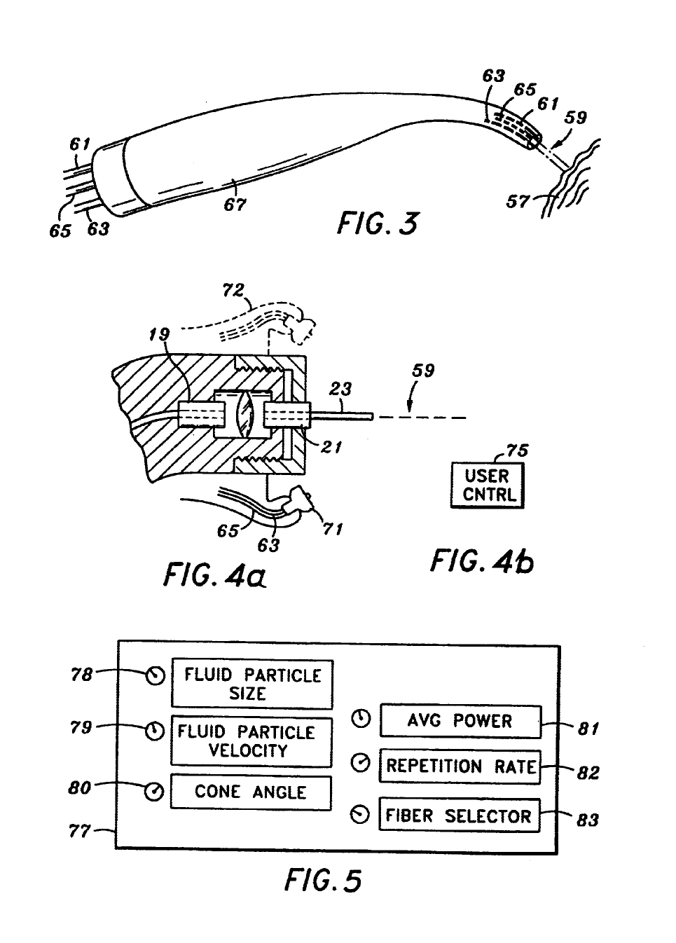

FIG. 4a illustrates the presently preferred embodiment of the electromagnetically induced cutter. The atomizer for generating atomized fluid particles comprises a nozzle 71, which may be interchanged with other nozzles (not shown) for obtaining various spatial distributions of the atomized fluid particles, according to the type of cut desired. A second nozzle 72, shown in phantom lines, may also be used. The cutting power of the electromagnetically induced cutter is further controlled by a user control 75 (FIG. 4b). In a simple embodiment, the user control 75 controls the air and water pressure entering into the nozzle 71. The nozzle 71 is thus capable of generating many different user-specified combinations of atomized fluid particles and aerosolized sprays.

Intense energy is emitted from the fiber optic guide 23. This intense energy is preferably generated from a coherent source, such as a laser. In the presently preferred embodiment, the laser comprises either an erbium, chromium, yttrium, scandium, gallium garnet (Er, Cr:YSGG) solid state laser, which generates electromagnetic energy having a wavelength in a range of 2.70 to 2.80 microns, or an erbium, yttrium, aluminum garnet (Er:YAG) solid state laser, which generates electromagnetic energy having a wavelength of 2.94 microns. As presently preferred, the Er, Cr:YSGG solid state laser has a wavelength of approximately 2.78 microns and the Er:YAG solid state laser has a wavelength of approximately 2.94 microns.

Although the fluid emitted from the nozzle 71 preferably comprises water, other fluids may be used and appropriate wavelengths of the electromagnetic energy source may be selected to allow for high absorption by the fluid. Other possible laser systems include an erbium, yttrium, scandium, gallium garnet (Er:YSGG) solid state laser, which generates electromagnetic energy having a wavelength in a range of 2.70 to 2.80 microns; an erbium, yttrium, aluminum garnet (Er:YAG) solid state laser, which generates electromagnetic energy having a wavelength of 2.94 microns; chromium, thulium, erbium, yttrium, aluminum garnet (CTE:YAG) solid state laser, which generates electromagnetic energy having a wavelength of 2.69 microns; erbium, yttrium orthoaluminate (Er:YALO3) solid state laser, which generates electromagnetic energy having a wavelength in a range of 2.71 to 2.86 microns; holmium, yttrium, aluminum garnet (Ho:YAG) solid state laser, which generates electromagnetic energy having a wavelength of 2.10 microns; quadrupled neodymium, yttrium, aluminum garnet (quadrupled Nd:YAG) solid state laser, which generates electromagnetic energy having a wavelength of 266 nanometers; argon fluoride (ArF) excimer laser, which generates electromagnetic energy having a wavelength of 193 nanometers; xenon chloride (XeCl) excimer laser, which generates electromagnetic energy having a wavelength of 308 nanometers; krypton fluoride (KrF) excimer laser, which generates electromagnetic energy having a wavelength of 248 nanometers; and carbon dioxide (CO2), which generates electromagnetic energy having a wavelength in a range of 9.0 to 10.6 microns. Water is chosen as the preferred fluid because of its biocompatibility, abundance, and low cost. The actual fluid used may vary as long as it is properly matched (meaning it is highly absorbed) to the selected electromagnetic energy source (i.e. laser) wavelength.

The electromagnetic energy source can be configured with the repetition rate greater than 1 Hz, the pulse duration range between 1 picosecond and 1000 microseconds, and the energy greater than 1 milliJoule per pulse. According to one operating mode of the present invention, the electromagnetic energy source has a wavelength of approximately 2.78 microns, a repetition rate of 20 Hz, a pulse duration of 140 microseconds, and an energy between 1 and 300 milliJoules per pulse.

In one preferred embodiment the electromagnetic energy source has a pulse duration on the order of nanoseconds, which is obtained by Q-switching the electromagnetic energy source, and in another preferred embodiment the electromagnetic energy source has a pulse duration on the order of picoseconds, which is obtained by mode locking the electromagnetic energy source. Q-switching is a conventional mode of laser operation which is extensively employed for the generation of high pulse power. The textbook, Solid-State Laser Engineering, Fourth Extensively Revised and Updated Edition, by Walter Koechner and published in 1996, the entire contents of which are expressly incorporated herein by reference, discloses Q-switching laser theory and various Q-switching devices. Q-switching devices generally inhibit laser action during the pump cycle by either blocking the light path, causing a mirror misalignment, or reducing the reflectivity of one of the resonator mirrors. Near the end of the flashlamp pulse, when maximum energy has been stored in the laser rod, a high Q-condition is established and a giant pulse is emitted from the laser. Very fast electronically controlled optical shutters can be made by using the electro-optic effect in crystals or liquids. An acousto-optic Q-switch launches an ultrasonic wave into a block of transparent optical material, usually fused silica. Chapter eight of the textbook, Solid-State Laser Engineering, Fourth Extensively Revised and Updated Edition, discloses the above-mentioned and other various Q-switching devices. Mode locking is a conventional procedure which phase-locks the longitudinal modes of the laser and which uses a pulse width that is inversely related to the bandwidth of the laser emission. Mode locking is discussed on pages 500-561 of the above-mentioned textbook entitled, Solid-State Laser Engineering, Fourth Extensively Revised and Updated Edition.

The atomized fluid particles provide the cutting forces when they absorb the electromagnetic energy within the interaction zone. These atomized fluid particles, however, provide a second function of cleaning and cooling the fiber optic guide from which the electromagnetic energy is output. The delivery system 55 (FIG. 2) for delivering the electromagnetic energy includes a fiber optic energy guide or equivalent which attaches to the laser system and travels to the desired work site. Fiber optics or waveguides are typically long, thin and lightweight, and are easily manipulated. Fiber optics can be made of calcium fluoride (CaF), calcium oxide (CaO2), zirconium oxide (ZrO2), zirconium fluoride (ZrF), sapphire, hollow waveguide, liquid core, TeX glass, quartz silica, germanium sulfide, arsenic sulfide, germanium oxide (GeO2), and other materials. Other delivery systems include devices comprising mirrors, lenses and other optical components where the energy travels through a cavity, is directed by various mirrors, and is focused onto the targeted cutting site with specific lenses. The preferred embodiment of light delivery for medical applications of the present invention is through a fiber optic conductor, because of its light weight, lower cost, and ability to be packaged inside of a handpiece of familiar size and weight to the surgeon, dentist, or clinician. In industrial applications, non-fiber optic systems may be used.

The nozzle 71 is employed to create an engineered combination of small particles of the chosen fluid. The nozzle 71 may comprise several different designs including liquid only, air blast, air assist, swirl, solid cone, etc. When fluid exits the nozzle 71 at a given pressure and rate, it is transformed into particles of user-controllable sizes, velocities, and spatial distributions. The nozzle may have spherical, oval, or other shaped openings of any of a variety of different sizes, according to design parameters.

FIG. 5 illustrates a control panel 77 for allowing user-programmability of the atomized fluid particles. By changing the pressure and flow rates of the fluid, for example, the user can control the atomized fluid particle characteristics. These characteristics determine absorption efficiency of the laser energy, and the subsequent cutting effectiveness of the electromagnetically induced cutter. This control panel may comprise, for example, a fluid particle size control 78, a fluid particle velocity control 79, a cone angle control 80, an average power control 81, a repetition rate 82 and a fiber selector 83.

The cone angle may be controlled, for example, by changing the physical structure of the nozzle 71. Various nozzles 71 may be interchangeably placed on the electromagnetically induced cutter. Alternatively, the physical structure of a single nozzle 71 may be changed.

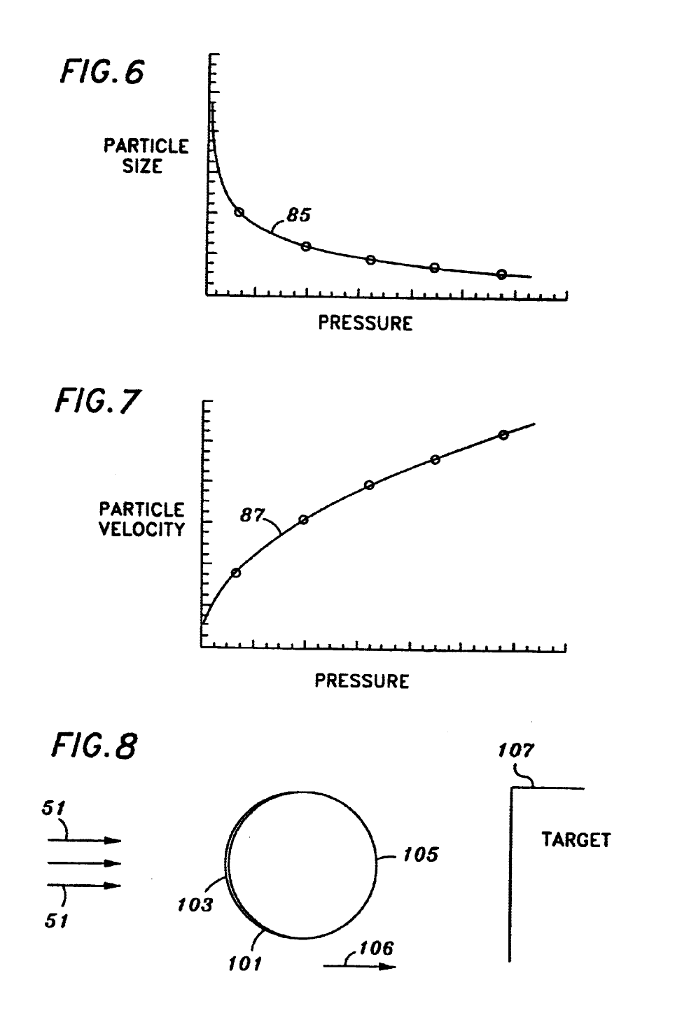

FIG. 6 illustrates a plot 85 of mean fluid particle size versus pressure. According to this figure, when the pressure through the nozzle 71 is increased, the mean fluid particle size of the atomized fluid particles decreases. The plot 87 of FIG. 7 shows that the mean fluid particle velocity of these atomized fluid particles increases with increasing pressure.

According to the present invention, materials are removed from a target surface by cutting forces, instead of by conventional thermal cutting forces. Laser energy is used only to induce forces onto the targeted material. Thus, the atomized fluid particles act as the medium for transforming the electromagnetic energy of the laser into the energy required to achieve the cutting effect of the present invention. The laser energy itself is not directly absorbed by the targeted material. The interaction of the present invention is safer, faster, and eliminates the negative thermal side-effects typically associated with conventional laser cutting systems.

The fiber optic guide 23 (FIG. 4a) can be placed into close proximity of the target surface. This fiber optic guide 23, however, does not actually contact the target surface. Since the atomized fluid particles from the nozzle 71 are placed into the interaction zone 59, the purpose of the fiber optic guide 23 is for placing laser energy into this interaction zone, as well. One feature of the present invention is the formation of the fiber optic guide 23 of straight or bent sapphire. Regardless of the composition of the fiber optic guide 23, however, another feature of the present invention is the cleaning effect of the air and water, from the nozzle 71, on the fiber optic guide 23.

The present inventors have found that this cleaning effect is optimal when the nozzle 71 is pointed somewhat directly at the target surface. For example, debris from the cutting are removed by the spray from the nozzle 71.

Additionally, the present inventors have found that this orientation of the nozzle 71, pointed toward the target surface, enhances the cutting efficiency of the present invention. Each atomized fluid particle contains a small amount of initial kinetic energy in the direction of the target surface. When electromagnetic energy from the fiber optic guide 23 contacts an atomized fluid particle, the exterior surface of the fluid particle acts as a focusing lens to focus the energy into the water particle's interior. As shown in FIG. 8, the water particle 101 has an illuminated side 103, a shaded side 105, and a particle velocity 107. The focused electromagnetic energy is absorbed by the water particle 101, causing the interior of the water particle to heat and explode rapidly. This exothermic explosion cools the remaining portions of the exploded water particle 101. The surrounding atomized fluid particles further enhance cooling of the portions of the exploded water particle 101. A pressure-wave is generated from this explosion. This pressure-wave, and the portions of the exploded water particle 101 of increased kinetic energy, are directed toward the target surface 107. The incident portions from the original exploded water particle 101, which are now traveling at high velocities with high kinetic energies, and the pressure-wave, impart strong, concentrated, forces onto the target surface 107.

These forces cause the target surface 107 to break apart from the material surface through a “chipping away” action. The target surface 107 does not undergo vaporization, disintegration, or charring. The chipping away process can be repeated by the present invention until the desired amount of material has been removed from the target surface 107. Unlike prior art systems, the present invention does not require a thin layer of fluid. In fact, it is preferred that a thin layer of fluid does not cover the target surface, since this insulation layer would interfere with the above-described interaction process.

The nozzle 71 is preferably configured to produce atomized sprays with a range of fluid particle sizes narrowly distributed about a mean value. The user input device for controlling cutting efficiency may comprise a simple pressure and flow rate gauge 75 (FIG. 4b) or may comprise a control panel as shown in FIG. 5, for example. Upon a user input for a high resolution cut, relatively small fluid particles are generated by the nozzle 71. Relatively large fluid particles are generated for a user input specifying a low resolution cut. A user input specifying a deep penetration cut causes the nozzle 71 to generate a relatively low density distribution of fluid particles, and a user input specifying a shallow penetration cut causes the nozzle 71 to generate a relatively high density distribution of fluid particles. If the user input device comprises the simple pressure and flow rate gauge 75 of FIG. 4b, then a relatively low density distribution of relatively small fluid particles can be generated in response to a user input specifying a high cutting efficiency. Similarly, a relatively high density distribution of relatively large fluid particles can be generated in response to a user input specifying a low cutting efficiency.

Soft tissues may include fat, skin, mucosa, gingiva, muscle, heart, liver, kidney, brain, eye, and vessels, and hard tissue may include tooth enamel, tooth dentin, tooth cementum, tooth decay, amalgam, composites materials, tarter and calculus, bone, and cartilage. The term “fat” refers to animal tissue consisting of cells distended with greasy or oily matter. Other soft tissues such as breast tissue, lymphangiomas, and hemangiomas are also contemplated. The hard and soft tissues may comprise human tissue or other animal tissue. Other materials may include glass and semiconductor chip surfaces, for example. The electromagnetically induced cutting mechanism can be further be used to cut or ablate biological materials, ceramics, cements, polymers, porcelain, and implantable materials and devices including metals, ceramics, and polymers. The electromagnetically induced cutting mechanism can also be used to cut or ablate surfaces of metals, plastics, polymers, rubber, glass and crystalline materials, concrete, wood, cloth, paper, leather, plants, and other man-made and naturally occurring materials. Biological materials can include plaque, tartar, a biological layer or film of organic consistency, a smear layer, a polysaccharide layer, and a plaque layer. A smear layer may comprise fragmented biological material, including proteins, and may include living or decayed items, or combinations thereof. A polysaccharide layer will often comprise a colloidal suspension of food residue and saliva. Plaque refers to a film including food and saliva, which often traps and harbors bacteria therein. These layers or films may be disposed on teeth, other biological surfaces, and nonbiological surfaces. Metals can include, for example, aluminum, copper, and iron.

A user may adjust the combination of atomized fluid particles exiting the nozzle 71 to efficiently implement cooling and cleaning of the fiber optic guide 23 (FIG. 4a), as well. According to the present invention, the combination of atomized fluid particles may comprise a distribution, velocity, and mean diameter to effectively cool the fiber optic guide 23, while simultaneously keeping the fiber optic guide 23 clean of particular debris which may be introduced thereon by the surgical site.

Looking again at FIG. 8, electromagnetic energy contacts each atomized fluid particle 101 on its illuminated side 103 and penetrates the atomized fluid particle to a certain depth. The focused electromagnetic energy is absorbed by the fluid, inducing explosive vaporization of the atomized fluid particle 101.

The diameters of the atomized fluid particles can be less than, almost equal to, or greater than the wavelength of the incident electromagnetic energy. In each of these three cases, a different interaction occurs between the electromagnetic energy and the atomized fluid particle. When the atomized fluid particle diameter is less than the wavelength of the electromagnetic energy (d<lambda), the complete volume of fluid inside of the fluid particle 101 absorbs the laser energy, inducing explosive vaporization. The fluid particle 101 explodes, ejecting its contents radially. As a result of this interaction, radial pressure-waves from the explosion are created and projected in the direction of propagation. The resulting portions from the explosion of the water particle 101, and the pressure-wave, produce the “chipping away” effect of cutting and removing of materials from the target surface 107. When the fluid particle 101 has a diameter, which is approximately equal to the wavelength of the electromagnetic energy (d=lambda), the laser energy travels through the fluid particle 101 before becoming absorbed by the fluid therein. Once absorbed, the distal side (laser energy exit side) of the fluid particle heats up, and explosive vaporization occurs. In this case, internal particle fluid is violently ejected through the fluid particle's distal side, and moves rapidly with the explosive pressure-wave toward the target surface. The laser energy is able to penetrate the fluid particle 101 and to be absorbed within a depth close to the size of the particle's diameter. When the diameter of the fluid particle is larger than the wavelength of the electromagnetic energy (d>lambda), the laser energy penetrates the fluid particle 101 only a small distance through the illuminated surface 103 and causes this illuminated surface 103 to vaporize. The vaporization of the illuminated surface 103 tends to propel the remaining portion of the fluid particle 101 toward the targeted material surface 107. Thus, a portion of the mass of the initial fluid particle 101 is converted into kinetic energy, to thereby propel the remaining portion of the fluid particle 101 toward the target surface with a high kinetic energy. This high kinetic energy is additive to the initial kinetic energy of the fluid particle 101. The effects can be visualized as a micro-hydro rocket with a jet tail, which helps propel the particle with high velocity toward the target surface 107. The electromagnetically induced cutter of the present invention can generate a high resolution cut. Unlike the cut of the prior art, the cut of the present invention is clean and precise. Among other advantages, this cut provides an ideal bonding surface, is accurate, and does not stress remaining materials surrounding the cut.

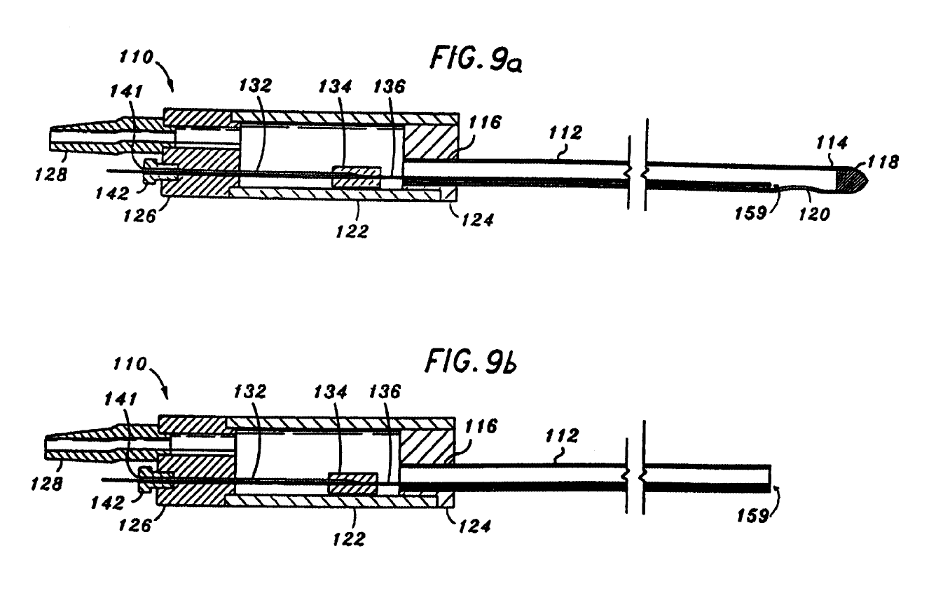

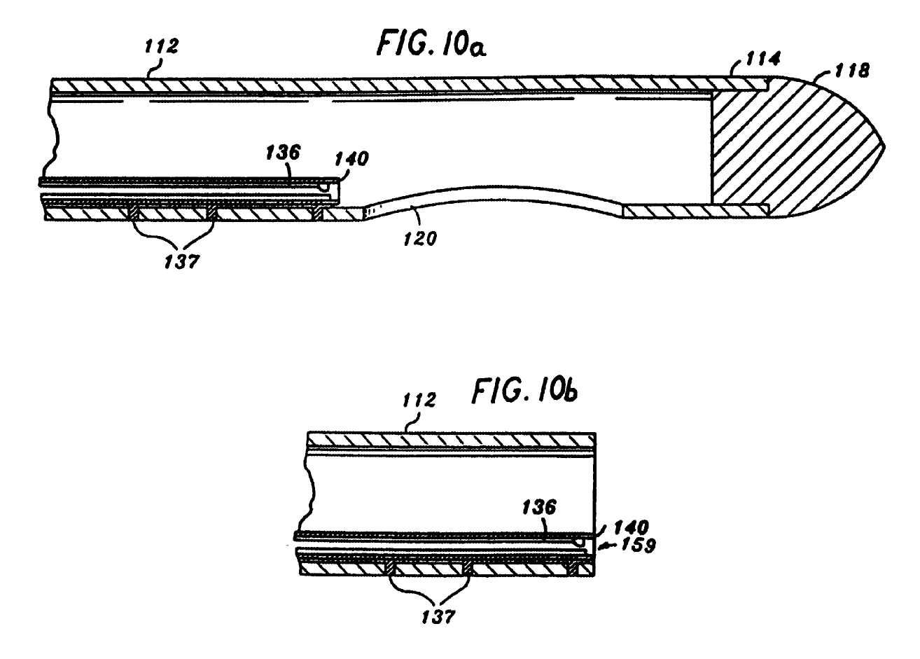

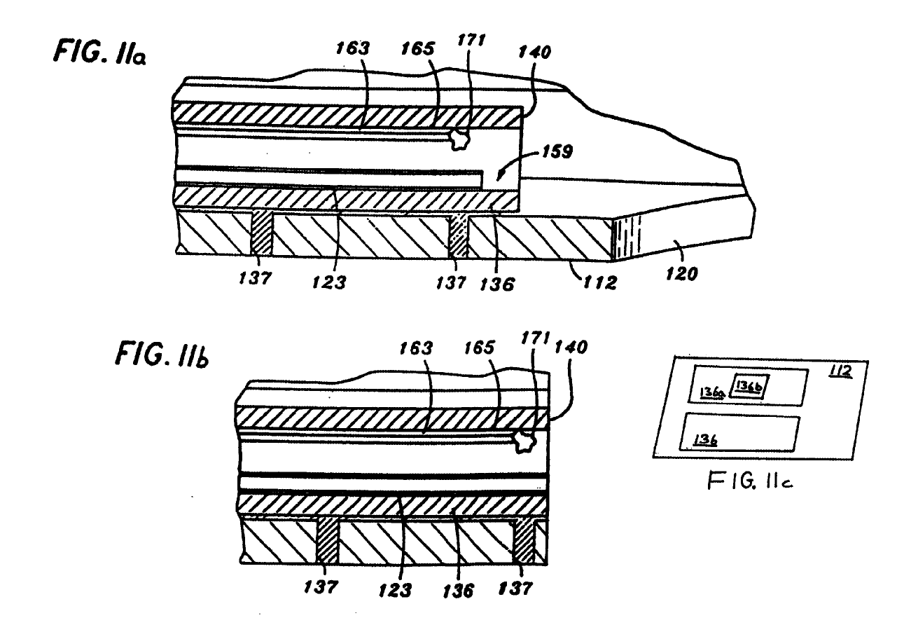

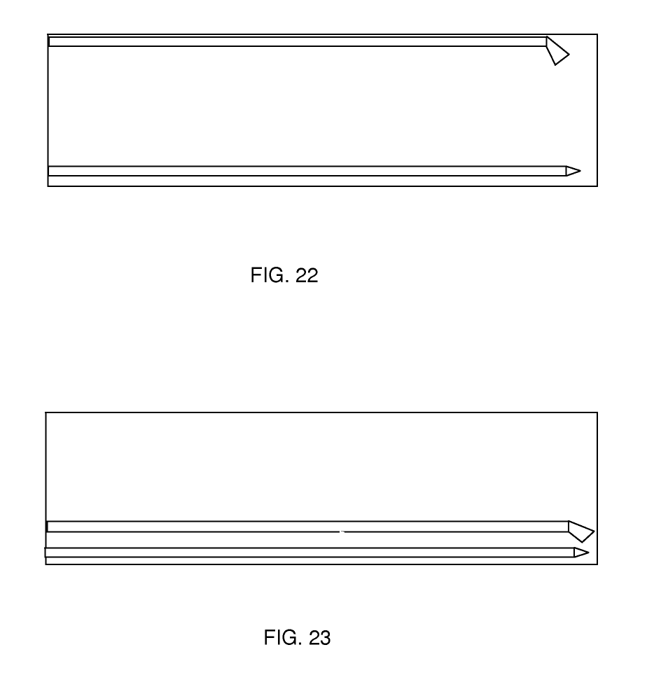

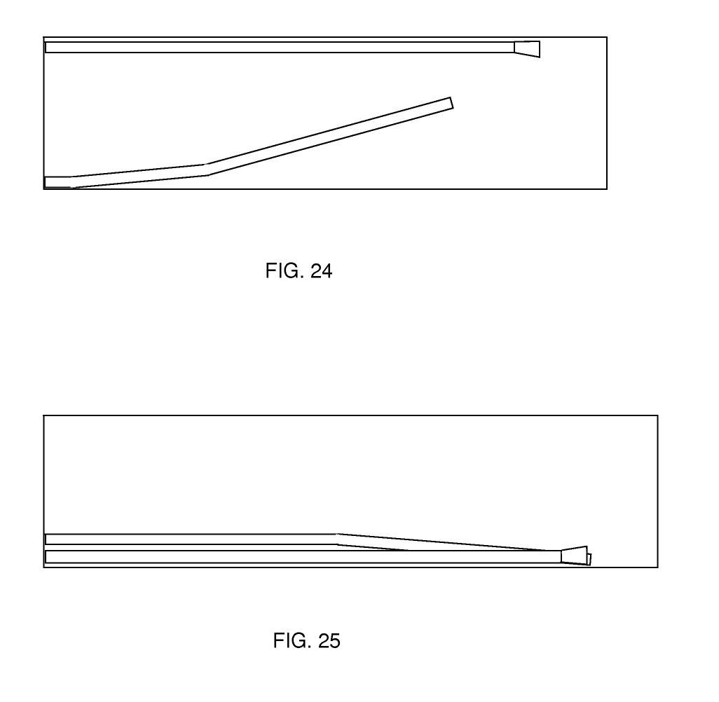

FIGS. 9-25 illustrate a tissue remover 110 which utilizes an electromagnetically induced cutter in accordance with the present invention. The tissue remover 110 includes an aspiration cannula 112 having soft tissue aspiration inlet port 120 adjacent to the distal end 114 and cannula tip 118 in the configuration presented in FIGS. 9a and 10a. As illustrated in FIGS. 9a and 10a the cannula tip 118 can advantageously be a generally rounded, blunt or bullet shaped tip attached to the cannula 112 by welding or soldering. In FIGS. 9b and 10b, the tissue remover 110 is configured to have an open cannula configuration. As illustrated in FIG. 9, the cannula proximal end 116 is retained within the distal handle end cap 124, the aspirated soft tissue outlet port 128 is retained within the proximal handle end cap 126, and the distal handle end cap 124 and proximal handle end cap 126 are retained within the handle 122. The soft tissue outlet port 128 is connected to an aspiration source by a plastic tubing (not shown).

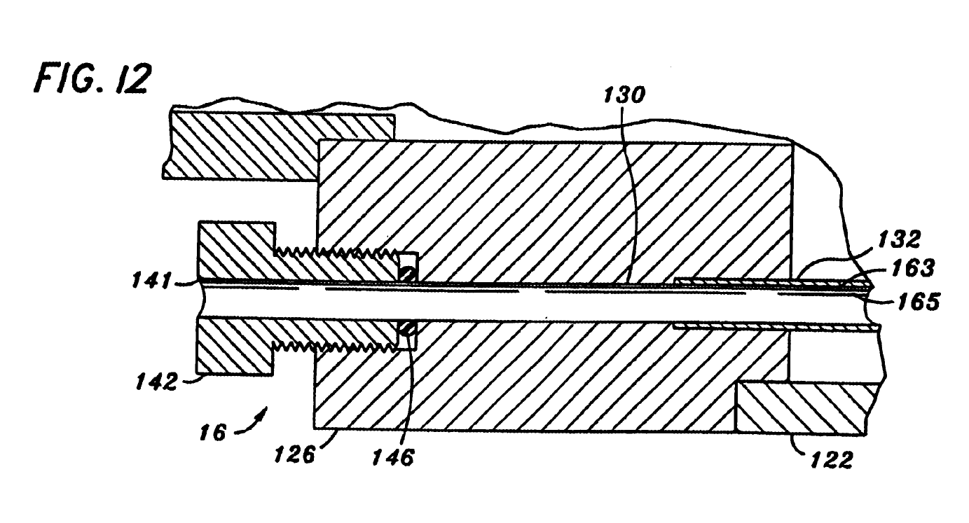

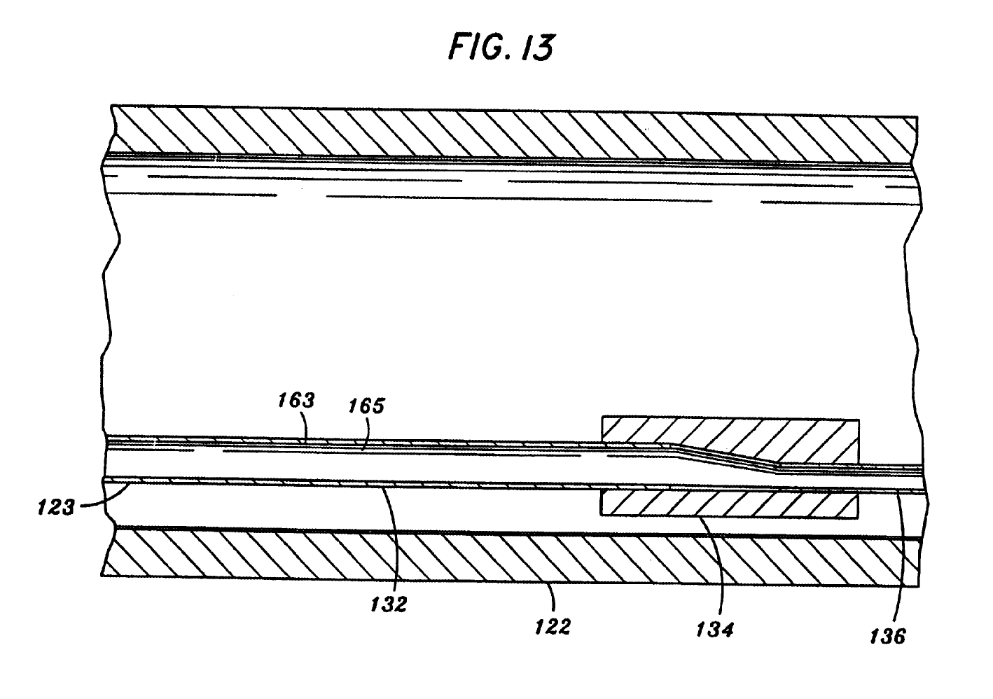

As illustrated in FIGS. 9-25, a fluid and laser fiber guide tube extends longitudinally within the tissue remover 110 from the proximal handle end cap 126, at the laser and fluid source port 141, terminating at a point 140 (FIG. 10) immediately proximal to the soft tissue aspiration inlet port 120 in the embodiment shown in FIG. 10a. In FIG. 10b, the laser and fluid source port 161 terminates at point 140 adjacent to the interaction zone 159. The fluid and laser fiber guide tube 136 resides partially within a coaxial fluid channel 130 (FIG. 12) drilled in the proximal handle end cap 126, and comprises a large fluid and laser fiber guide tube 132, a guide tube transition coupler 134, and a small fluid and laser fiber guide tube 136. The guide tube transition coupler 134 is positioned within the handle 122 proximal to the proximal end of the cannula 116 and is drilled to accommodate the external diameters of the large 132 and small guide tubes 136. The guide tube components are joined together and to the proximal handle end cap 126 and within the aspiration cannula inner wall utilizing a means such as soldering or welding. The fluid and laser guide tube can be provided with an O-ring seal 146 (FIG. 12) at its retention within the proximal handle end cap 126 at the laser energy source port 141. The optional guide tube transition coupler 134 can be used to provide for a small fluid and laser fiber guide tube 136 having a relatively small diameter. The optional guide tube transition coupler 134 also allows for more space within the aspiration cannula 112.

Housed within the fluid and laser fiber guide tube is the laser fiber optic delivery system. As shown in FIG. 11, the laser fiber optic delivery system comprises a fiber optic guide 123, an air tube 163 and a water tube 165. The fiber optic guide 123, air tube 163 and water tube 165 are preferably similar to the fiber optic guide 23, air tube 63 and water tube 65 described above with reference to FIG. 4a. The water tube 165 is preferably connected to a saline fluid source and pump, and the air tube is preferably connected to a pressurized source of air. The air tube 163 and the water tube 165 are terminated with a nozzle 171 which is preferably similar to the nozzle 171 described above with reference to FIG. 4a. In one embodiment, the fiber optic guide 123, air tube 163, and water tube 165 operate together to generate electromagnetically induced cutting forces. In other embodiments of the invention, there is only a water tube 165. In a typical implementation with no air tube, only a fluid tube, such as water tube 165, is connected to the nozzle 171. In such a case, the nozzle 171 is a water-only type of nozzle. Any of the above-described configurations may be implemented to generate such forces, in modified embodiments.

Other implementations of the invention may be constructed without a fluid and laser fiber guide tube, wherein, for example, one or more of the air tube and the water tube may be omitted with the non-omitted tube or tubes being disposed directly within the aspiration cannula. For instance, the one or more non-omitted tube or tubes can be coupled to inner-wall surfaces of the aspiration cannula. In still other implementations of the invention, the aspiration cannula may be omitted with, for example, just the fluid and laser fiber guide tube being used to accomplish treatment procedures; such implementations may comprise a fluid (e.g., water) tube with or without an air tube.

According to an aspect of current invention, a device and method for tunneling through cartilage and, especially, hard tissue (e.g., bone), is provided. The invention can be used in arthroscopic surgical procedures for treatment of, among other things: (i) torn menisci, anterior cruciate, posterior cruciate, patella malalignment, synovial diseases, loose bodies, osteal defects, osteophytes, and damaged articular cartilage (chondromalacia) of the knee; (ii) synovial disorders, labial tears, loose bodies, rotator cuff tears, anterior impingement and degenerative joint disease of the acromioclavicular joint and diseased articular cartilage of the shoulder joint; (iii) synovial disorders, loose bodies, osteophytes, and diseased articular cartilage of the elbow joint; (iv) synovial disorder, loose bodies, ligament tears and diseased articular cartilage of the wrist; (v) synovial disorders, loose bodies, labrum tears and diseased articular cartilage in the hip; and (vi) synovial disorders, loose bodies, osteophytes, fractures, and diseased articular cartilage in the ankle. According to the Summary, the current invention can be applied to precisely and cleanly shave, reshape, cut through or remove cartilage, fibrous cartilage, or bone.

With reference to FIGS. 9b, 10b, 11b and 14-25, a leading surface of the cannula can be configured without a sharpened tip (e.g., shaped to pierce, cut, or disrupt tissue) and, instead, according to a preferred implementation, the laser and fluid are configured to perform at least in part, and, in typical applications, substantially all, of the cutting, with the cannula distal end emitting such items (laser and fluid) to effectuate tunneling of the device through the tissue.

An aspect of the invention can comprise the interaction zone being positioned off-axis to the central (longitudinal) axis of the cannula so that during tunneling through, for example, cartilage or hard tissue such as bone the cannula can be rotated about its axis to generate a “tunnel” sufficiently sized in width (e.g., diameter) to allow the cannula to be advanced therethrough. For instance, in an implementation wherein the cannula has a cylindrical shape, that shape can be, for the purpose of discussion, considered to encircle a cylindrical volume. Now, if that cylindrical volume is conceptualized to extend distally in front of the cannula to define a leading cylindrical volume, then the invention, according to the mentioned aspect, provides cutting forces that fully encompass that leading cylindrical volume in a vicinity adjacent to the leading or distal end of the cannula, so that such cutting forces clear the way for distal advancement of the cannula through the cylindrical volume.

According to a particular implementation, the cutting forces not only fully encompass the leading cylindrical volume immediately and distally adjacent to the distal end of the cannula, but further cover a volume having a radius slightly greater than the cylindrical volume, by operation of the energy wave guide (e.g., cutting fiber optic) being disposed with an orientation which is not parallel to a longitudinal axis of the cannula (“cannula axis”) and which, furthermore, is oriented to facilitate emission of cutting forces having an axis (or average direction) that diverges from the cannula axis in the distal direction. Thus, cutting forces can operate to clear the way for distal advancement of the cannula through the leading cylindrical volume without such a tight (e.g., exact) fit. In other words, the cutting forces can be orchestrated to encompass a volume in the target, such as bone, that is larger, e.g., slightly larger, than the leading cylindrical volume.

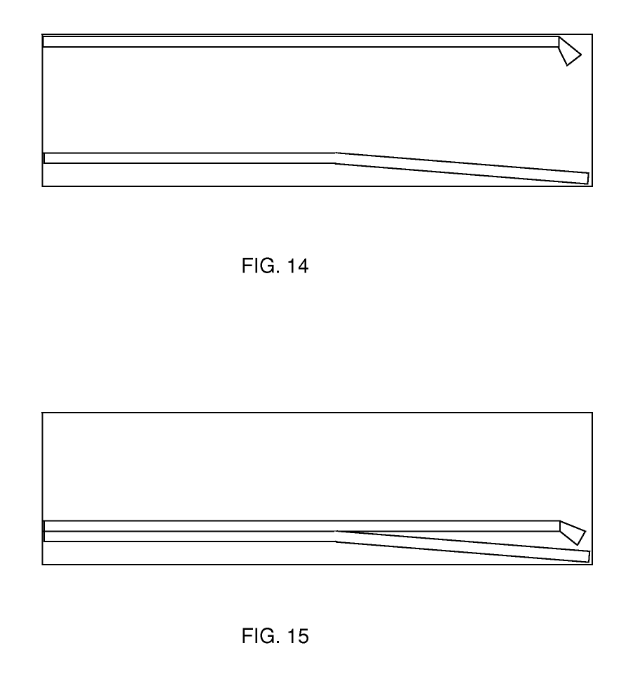

A particular implementation thus can comprise an axis of the fiber optic near the output end of the fiber optic that is not parallel to an axis of the cannula. FIG. 14 illustrates a particular implementation, wherein, at or near the distal end of the cannula, a distance between the axis of the fiber optic and the axis of the cannula diverges in the distal direction while a distance between the axis of the fiber optic and an axis of the fluid output (e.g., nozzle) converges in the distal direction. One arrangement for achieving such a combination of characteristics can comprise positioning of the fluid line and waveguide on opposing sides of the cannula axis. Another can, additionally, or alternatively, comprise securing the fluid line and waveguide on opposing sides of the inner surface of the cannula.

At or near the distal end of the cannula, an angle between the axis of the fiber optic and the axis of the cannula can range from about ½ to 45 degrees, or in certain implementations from about 1 to 30 degrees, or in an illustrated embodiment can be about 10 degrees. At or near the distal end of the cannula, an angle between the axis of the fiber optic and the axis of the fluid output can range from about ½ to 45 degrees, or in certain implementations from about 1 to 30 degrees, or in an illustrated embodiment can be about 10 degrees.

Another implementation can comprise an axis of the fiber optic near the output end of the fiber optic being non-parallel to an axis of the cannula such as depicted in FIG. 15. In that depiction, at or near the distal end of the cannula, a distance between the axis of the fiber optic and the axis of the cannula diverges in the distal direction along with a distance between the axis of the fiber optic and an axis of the fluid output (e.g., nozzle) also diverging in the distal direction. One arrangement for achieving this combination of characteristics comprises positioning the fluid line and waveguide on the same side of the cannula axis as shown; another is to additionally, or alternatively, secure the fluid line and waveguide close to but on opposing sides of the cannula axis, while yet another is to additionally, or alternatively, secure both the fluid line and waveguide very close to one another in any location such as with one or both being disposed adjacent to (e.g., contacting) an inner surface of the cannula.

At or near the distal end of the cannula, an angle between the axis of the fiber optic and the axis of the cannula can range from about ½ to 45 degrees, or in certain implementations from about 1 to 30 degrees, or in an illustrated embodiment can be about 10 degrees. At or near the distal end of the cannula, an angle between the axis of the fiber optic and the axis of the fluid output can range from about ½ to 45 degrees, or in certain implementations from about 1 to 30 degrees, or in an illustrated embodiment can be about 10 degrees.

Other aspects of the invention, which can be combined with any implementation, embodiment, or combination described herein, can comprise one or more of the fluid line and the waveguide (e.g., fiber optic) extending up to or distally beyond the distal end of the cannula. Alternatively, or additionally, one or more of the fluid line and the waveguide (e.g., fiber optic) can be recessed within the cannula in accordance, for example, with any part of Provisional Application 60/012,446, filed Dec. 9, 2007 and entitled CANNULA ENCLOSING RECESSED WAVEGUIDE OUTPUT TIP, the contents of which are incorporated herein by reference. Alternatively, or additionally, the output region of the waveguide (e.g., fiber optic) can comprise a non-cylindrical, a modified cylindrical, or an otherwise modified construction such as disclosed or referenced in whole or in part by (1) application Ser. No. 11/800,184, filed May 3, 2007 and entitled MODIFIED-OUTPUT FIBER OPTIC TIPS or (2) application Ser. No. 12/020,455, filed Jan. 25, 2008 and entitled MODIFIED-OUTPUT FIBER OPTIC TIPS, the contents of both which are incorporated herein by reference. Alternatively, or additionally, one or more additional fluid lines can be implemented such as disclosed or referenced in any part of application Ser. No. 11/042,824, filed Jan. 24, 2005 and entitled ELECTROMAGNETICALLY INDUCED TREATMENT DEVICES AND METHODS, the contents of which are incorporated herein by reference. Also, one or more of the structural and process features disclosed or referenced in Application 61/036,971, filed Mar. 16, 2008 and entitled ENDODONTIC ADJUSTABLE CHANNEL-DEPTH INDICATOR, the contents of which are incorporated herein by reference, may be combined, substituted or modified to be combined/substituted with any implementation, embodiment, or combination described herein as would be considered feasible by one skilled in the art.

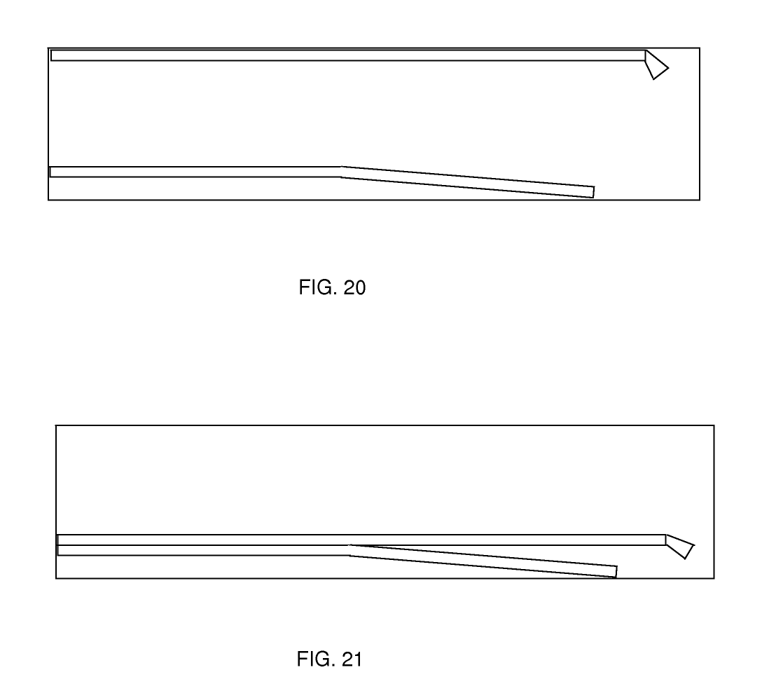

In any implementation described or referenced herein, part or all of the cannula may be formed of a material that is substantially or partially transparent to one or more wavelengths of electromagnetic energy, such as that of cutting laser radiation or of an aiming beam or other radiation such as illuminating visible light (as incorporated by referenced herein), and/or such as that may be supplied by the waveguide (e.g., fiber optic). For instance, with reference to FIGS. 20-25, one or more regions of a sidewall of the cannula, such as a region of the sidewall through which radiation may pass, may comprise one or more of a non-opaque, transparent, clear, and/or see-through material. Additionally, or alternatively, the fiber optic may be recessed more (relative to the implementations of one or more of FIGS. 14-25) proximally within the lumen and/or oriented at a different angle to direct substantially or part of the radiation through the transparent region. Furthermore, additionally or alternatively, the fluid line and/or nozzle may be recessed more, proximally, within the lumen and/or oriented at a different angle to direct fluid in a commensurately different fashion, direction and/or manner. The fluid line and/or another fluid line may be located outside of the cannula to intersect or otherwise interact with radiation exiting from the transparent region and/or may be omitted (such as, for example, in an aqueous-environment procedure).

In other implementations, the above-discussed region may additionally, or alternatively, comprise a member extending over the distal end of the cannula, which member may comprise, in non-obvious and non-interchangeable varying embodiments, any cannula distal-end shape known to those skilled in the art. In such implementations, the distal-end region may comprise, substantially or partially, one or more of a non-opaque, transparent, clear, and/or see-through material. Additionally, or alternatively, the fiber optic may be oriented within the lumen and/or positioned at a different angle to direct radiation, at least in part, through the distal-end region. Furthermore, additionally or alternatively, the fluid line and/or nozzle may be configured or positioned within the lumen and/or oriented at a different angle to direct fluid in a commensurately different fashion, direction and/or manner. The fluid line and/or another fluid line may be located outside of the cannula to intersect or otherwise interact with radiation exiting from the distal-end region and/or may be omitted (such as, for example, in a procedure performed within a liquid environment).

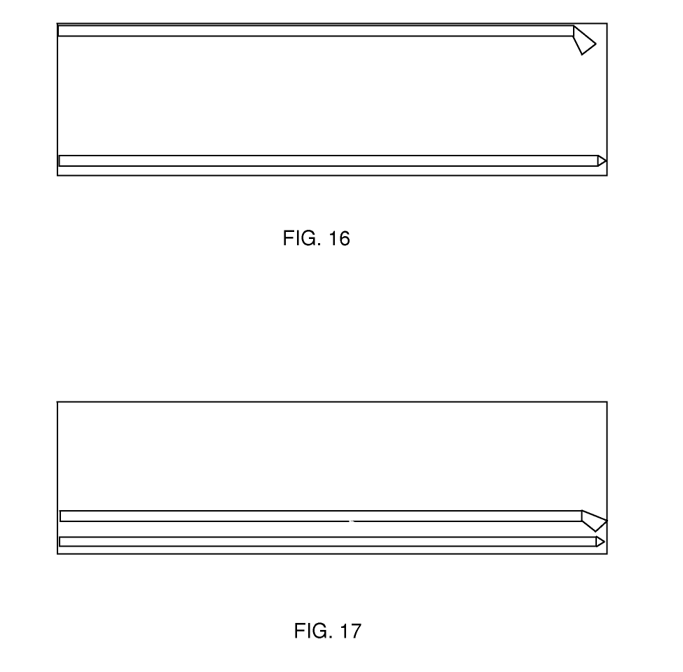

FIGS. 16 and 17 disclose modified output (e.g., side firing) waveguide implementations corresponding in some ways to FIGS. 14 and 15 but with modifications including, for example, one or more of: modified (e.g., cone shaped) output regions (c.f. FIGS. 16 and 17), relatively linear (e.g., having a smaller bend or less curvature) waveguides (c.f. FIGS. 16 and 17 compared to FIGS. 14 and 15), greater separations of waveguides from fluid lines yielding less obstructed and/or more usable lumen volumes (c.f. FIG. 16 compared to FIG. 14), and/or closer dispositions of waveguides to the inner cannula wall (cf. FIG. 17 compared to FIG. 15).

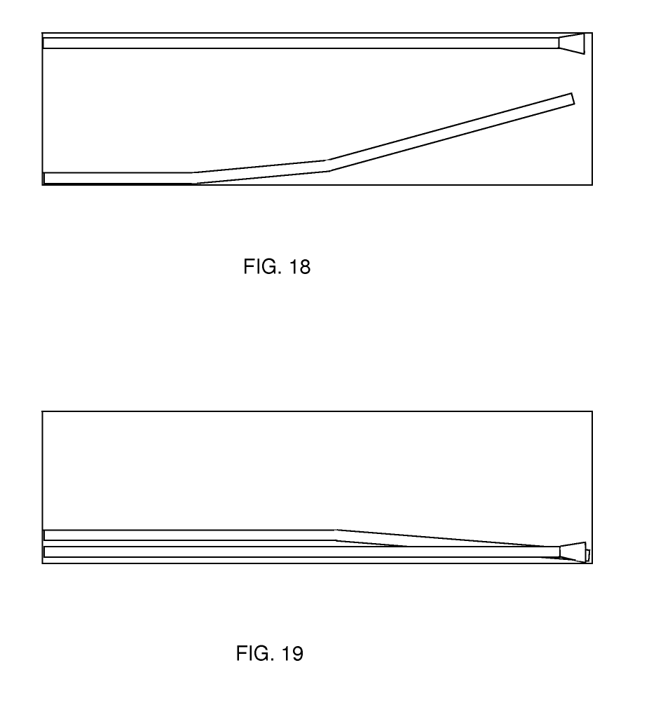

Still another implementation can comprise an axis of the fiber optic near the output end of the fiber optic being non-parallel to an axis of the cannula such as depicted in FIG. 18. In that depiction, at or near the distal end of the cannula, a distance between the axis of the fiber optic and the axis of the cannula converges in the distal direction and a distance between the axis of the fiber optic and an axis of the fluid output (e.g., nozzle) converges in the distal direction. One arrangement for achieving this combination of characteristics can comprise the positioning of the fluid line and waveguide on different (e.g., opposing) sides of the inner cannula wall as shown; another can comprise, additionally, or alternatively, securing the fluid line and waveguide close to but on opposing sides of the cannula axis, while yet another can be, additionally, or alternatively, to secure both the fluid line and waveguide very close to one another in any location such as with one or both being adjacent to (e.g., contacting) an inner surface of the cannula. At or near the distal end of the cannula, an angle between the axis of the fiber optic and the axis of the cannula can range from about ½ to 75 degrees, or in certain implementations from about 1 to 40 degrees, or in an illustrated embodiment can be about 20 degrees. At or near the distal end of the cannula, an angle between the axis of the fiber optic and the axis of the fluid output can range from about ½ to 75 degrees, or in certain implementations from about 1 to 40 degrees, or in an illustrated embodiment can be about 20 degrees.

A further implementation comprises an axis of the fiber optic near the output end of the fiber optic being non-parallel to an axis of the cannula such as depicted in FIG. 19, wherein, at or near the distal end of the cannula, a distance between the axis of the fiber optic and the axis of the cannula diverges in the distal direction and a distance between the axis of the cannula and an axis of the fluid output (e.g., nozzle) remains about the same in the distal direction. An arrangement for achieving this combination of characteristics can comprise positioning the fluid line and waveguide on the same side of the inner cannula wall as shown; another is to additionally, or alternatively, secure the fluid line and waveguide close to and/or on opposing sides of the cannula axis, while yet another is to additionally, or alternatively, secure both the fluid line and waveguide very close to one another in any location such as with one or both being adjacent to (e.g., contacting) an inner surface of the cannula.

In the presently preferred embodiment wherein the fluid emitted from the water tube is water-based and the electromagnetic energy from the fiber optic guide 123 is highly absorbed by the water, it is desirable to have a relatively non-aqueous environment (wherein body fluids are minimized) between the output end of the fiber optic guide 123 and the target surface. It is also preferred to maintain a non-aqueous environment between the nozzle 171 and the interaction zone 159 (FIG. 11) for generation of the atomized distributions of fluid particles. An element of the present invention involves keeping body fluids clear from the nozzle 171 and the interaction zone 159 enhances performance. Accordingly, means for reducing bleeding are preferred. In this connection, the distal blade of the cannula tip 118 can comprise a radio frequency (RF) cutting wire. Electrosurgery procedures using RF cutting wires implement high frequency (radio frequency) energy for implementing cutting of soft tissue and various forms of coagulation.

In electrosurgery, the high density of the RF current applied by the active electrosurgical electrode causes a cutting action, provided the electrode has a small surface (wire, needle, lancet, scalpel). Additionally the current waveform is a significant factor in the cutting performance. A smooth, non-modulated current is more suitable for scalpel-like cutting, whereas the modulated current gives cuts with predetermined coagulation. The output intensity selected, as well as the output impedance of the generator, are also important with respect to cutting performance. The electrosurgical cutting electrode can be a fine micro-needle, a lancet, a knife, a wire or band loop, a snare, or even an energized scalpel or scissors. Depending on (1) the shape of the electrode, (2) the frequency and wave modulation, (3) the peak-to-peak voltage, and (4) the current and output impedance of the generator, the cut can be smooth, with absolutely no arcing, or it can be charring and burn the tissue. Electrosurgical coagulation may be carried out, for example, by implementing light charring and burning in a spray coagulation mode. The biological effect, accordingly, can significantly differ from gentle tissue dehydration to burning, charring and even carbonization. The temperature differences during the various coagulation process may vary between 100 degrees Celsius to well over 500 degrees Celsius The means should be chosen in accordance with the amount of cutting and/or coagulation that is desired, which will be a function of various parameters such as the type of tissue being cut. In accordance with an object of the present invention of reducing smoke, bipolar applications or cutting with no-modulated current are preferred.

Pressurized air, N₂ or O₂ can be output from the air tube 163 at various flow rates and various intervals, either during cutting or between cutting, in order to provide a relatively non-aqueous working environment for the electromagnetically induced cutting forces. Insufflation procedures, for example, for generating air cavities in the vicinity of the target tissue to be cut and removed can be used to attenuate the introduction of unwanted body liquids in the interaction zone 159.

In accordance with the presently preferred embodiment, the negative pressure generated and transmitted by the flexible suction tubing serves to evacuate from the interaction zone 159 body fluids, removed tissue, and air and water from the nozzle 171. As presently embodied, the large fluid and laser fiber guide tube 132 is connected to a source of air and the negative pressure generated and transmitted by the flexible suction tubing serves to draw the air through the large fluid and laser fiber guide tube 132 and the small fluid and laser fiber guide tube 136. The source of air coupled to the large fluid and laser fiber guide tube 132 preferably comprises moist air. The flow of air out of the small fluid and laser fiber guide tube 136 serves to keep the nozzle 171, the output end 140 of the fiber optic guide 123, and the interaction zone 159 relatively free of body fluids. If additional removal of body fluids is desired, one or more pressurized air lines can be routed to distal end 114 of the cannula 114 adjacent to the cannula tip 118. The pressurized air line or lines can be activated to introduce air into the lumen of the cannula at the distal end of the cannula to thereby facilitate the removal of body fluids and water from the lumen. Effective removal of body fluids and water from the distal end of the cannula, including the interaction zone 159 and the portion of the lumen distal of the aspiration inlet port, occurs when fatty tissue within the aspiration inlet port forms a seal within the lumen of the cannula so any body fluids are drawn out to the cannula lumen by the negative pressure. The pressurized air line of lines provide displacement for the fluids as they are removed. If the body fluids are viscous then water from the water tube 165 can be introduced to attenuate the viscosity of and accelerate the removal of the body fluids.

In accordance with the presently preferred embodiment only water or saline is delivered to the nozzle 171 during cutting. In other embodiments, the liquid delivered to the nozzle 171 carries different medications such as anesthetics, epinephrines, etc. The anesthetic may comprise, for example, lydocaine. The use of anesthetics and vessel constrictors, such as epinephrines, may help to provide anesthesia during and after surgery, and to reduce blood loss. One or more controls disposed proximally of the aspirated soft tissue outlet port 120 can allow the user to adjust the percent of air and/or water that is directed to the nozzle 171 at any given time. In the presently preferred embodiment a control panel, having one or more of the features of the control panel 77 shown in FIG. 5, is used to control, among other things, whether water alone, air alone, a combination of air and water, or a combination of air and medicated liquid is supplied to the nozzle 171.

The large guide tube 132 is maintained in position within cannula 112, for example, by silver solder through holes 137, as illustrated in FIGS. 10 and 11. The retention of the laser fiber optic delivery system is accomplished by a retaining screw 142 at the fluid, air and laser energy source port 141. As will be apparent to those skilled in this art, a shorter and thinner soft tissue aspiration cannula 112 will be useful in more restricted areas of the body, as under the chin, and a longer and larger diameter cannula will be useful in areas such as the thighs and buttocks where the cannula may be extended into soft tissue over a more extensive area. The cannula can be either rigid or flexible depending on the type of access necessary to reach the surgical site.

To perform the method of the present invention as illustrated in FIG. 14, the surgeon determines the location and extent of soft tissue to be removed. The appropriate size tissue remover 110 is selected. A short incision is made and the cannula tip 118 and the distal end of the cannula 114 are passed into the soft tissue to be removed. Air and sterile water/saline are delivered through the air and water tubes 163 and 165. The saline may help to facilitate the removal of fatty tissues. The aspiration pump is then activated. The resultant negative pressure thus generated is transmitted to the tissue remover 110 via a flexible suction tubing, to the soft tissue outlet port 128, through the handle 122, through the cannula 112, to the soft tissue aspiration inlet port 120. The resultant negative pressure at the inlet port draws a small portion of the soft tissue into the lumen of the cannula 112, into close proximity with the interaction zone 159 (FIG. 11a), or into the interaction zone 159 only when the cannula does not include an inlet port 120 such as the cannulas shown in FIGS. 9b, 10b and 11b. In the embodiment of FIGS. 9b, 10b and 11b, negative pressure may not be required, wherein the cannula 112 is advanced to close proximity of the target surface to be cut. The edges of the cannula 112 distal end are preferably generally rounded or bullet-shaped to facilitate insertion into the patient's tissue with a minimum of localized tissue trauma. The nozzle 171 and the output end of the fiber optic guide 123 may be disposed in a slightly proximal location, relative to the configuration shown in FIG. 11b, so that the output end of the fiber optic guide 123 is proximal of the distal end of the small fluid and laser fiber guide tube 136. Once the target tissue is positioned just distally of the interaction zone 159, the laser is activated and electromagnetically induced cutting forces are imparted onto the soft tissue within the cannula lumen, cleaving the soft tissue. Additional soft tissue enters the soft tissue aspiration inlet port 120 by virtue of a reciprocating longitudinal motion of the tissue remover 110 within the soft tissue. This reciprocating motion is applied by the surgeon's hand on the handle 122. The reciprocating motion of the tissue remover 110, with respect to the surrounding soft tissue, is facilitated by the stabilization of the soft tissue by the surgeon's other hand placed on the skin overlying the cannula soft tissue aspiration inlet port 120. Soft tissue that is cut or ablated near the interaction zone 159 is drawn and removed to the more proximal portion of the lumen of the cannula, and eventually out the cannula to the soft tissue outlet port 128 by the negative pressure generated by the aspiration pump.

Depending on the type of cannula or catheter used for the procedure, endoscopes for providing an image of the surgical site can be classified in three categories. Category 1 endoscopes include rigid scopes using a series of rigid rods coupled to the objective to capture the image of the targeted tissue. The rigid scopes provide the best image quality with limited maneuverability. Category 2 endoscopes include flexible scopes using optical fiber bundles of up to ten thousand fibers in a bundle to capture the image from the objective lens to the camera. Their final image is a mosaic of the images gathered by each fiber in the bundle, and this image has lower resolution than the image resulted from the rigid scope. Surgical procedures inside tiny ducts, capillaries or locations within the body that do not allow for direct/straight access are examples of applications where flexible scopes are needed. Category 3 endoscopes include semi-rigid scopes that use optical fibers with limited flexibility. Through technological advancements of the imaging devices, new technologies have emerged, and some of them are still under development. An example of such an advancement is infrared imaging technology. The infrared imaging technology is based on a process of mapping temperature differences at the surgical site by detecting electromagnetic radiation from tissue that is at different temperatures from its surroundings. Based on this type of information, this imaging technology can provide the surgeon with more than just image information and data. For example, a medical condition of the treatment site can be established through such advanced imaging technology. All of the above imaging technologies can be implemented with the electromagnetic cutting device in accordance with the present invention in helping the clinician to monitor and visualize the surgical site during the procedure of cutting or removing tissue with electromagnetically induced cutter.

The soft tissue aspiration cannula 112, cannula tip 118, handle 122, distal handle end cap 124, proximal handle end cap 126, aspirated soft tissue outlet port 128, large fluid and laser fiber guide tube 132, guide transition coupler 134, small fluid and laser fiber guide tube 136, and retaining screw 142 are all preferably of stainless steel. In modified embodiments, some or all of the components comprise medical grade plastics. In a flexible cannula design, the cannula 112 is made out of a biocompatible or medical grade flexible plastic. In a modified embodiment, a disposable cannula, flexible or rigid, is constructed from a medical grade disposable plastic. As will be apparent to those of skill in this art, a shorter and thinner diameter aspiration cannula will be useful in more restricted areas of the body, as around small appendages, and a longer and larger diameter cannula will be useful in areas, such as the thighs and buttocks, where the cannula may be extended into fatty tissue over a more extensive area. The cannula tip 118 is in sizes of the same diameter as the aspiration cannula O.D., machined to a blunt tip and to fit the cannula inside diameter. The handle 122 is preferably of tubing. The distal handle end cap 124 is preferably machined to fit the handle inside diameter and drilled to accommodate the aspiration cannula outside diameter. The proximal handle end cap 126 is preferably machined to fit the handle inside diameter, drilled to accommodate the aspiration outlet port, fluid and laser guide channel, and large guide tube, and drilled and tapped to accommodate the retaining screw. The aspirated soft tissue outlet port 128 is preferably machined to fit the proximal handle end cap and tapered to accommodate appropriate suction tubing. The guide tube transition coupler 134 is preferably drilled to accommodate large and small guide tubes 132 and 136. The small fluid and laser fiber guide tube is determined by the length of the cannula 112.

By utilizing the present tissue remover 110 according to the present method, a variety of advantages are achieved. By enabling the cutting of the soft tissue in a straight line, the scooping, ripping and tearing action characteristic of prior-art devices, is attenuated, resulting in fewer contour irregularities and enhanced satisfaction. With the addition of the cutting action of the present invention the rate of removal of unwanted soft tissue can be enhanced over that of previous devices and techniques thus decreasing operative time. Benefits are obtained without fear of peripheral laser thermal damage.

In an arthroscopic procedure such as a menisectomy, for example, the cannula 112 has no cannula tip 118 and the tip of the fiber optic guide 123 is placed adjacent to the interaction zone 159 in the vicinity of the tissue target. The nozzle spray 171 delivers sterile water or saline to the interaction zone 159 and the process of cutting the miniscule cartilage in the knee is the same as described above and in the summary of the invention. Specifically, upon absorption of the electromagnetic energy, the atomized fluid particles within the interaction zone expand and impart cutting forces onto the meniscule cartilage tissue. The cartilage is then removed through this process and any tissue debris, together with the residual fluid, is quickly aspirated through the suction tube within the cannula. The same cannula device described for this procedure and presented in FIGS. 9b, 10b and 11b is used for neuroendoscopic and laparoscopic procedures. The procedures related to these applications follow the same steps as the procedure described for the removal of fatty tissues with the electromagnetic tissue remover. In all of these applications, the cannula 112 can include an additional tube that contains an imaging device required to visualize the surgical site during the procedure. FIG. 11c is a block diagram illustrating such an additional tube 136a and imaging device 136b within the cannula 112. The imager can also be provided through a separate cannula inserted through a different opening into the patient's treatment surgical site.

In accordance with the present invention, water from the water tube 165 can be conditioned with various additives. These additives may include procoagulants and anesthetics, for example. Other additives may be used, such as other medications. Co-pending U.S. application Ser. No. 08/995,241 filed on Dec. 17, 1997 and entitled FLUID CONDITIONING SYSTEM, which is a continuation of U.S. application Ser. No. 08/575,775, filed on Dec. 20, 1995 and entitled FLUID CONDITIONING SYSTEM which issued into U.S. Pat. No. 5,785,521, discloses various types of conditioned fluids that can be used with the electromagnetically induced cutter of the present invention in the context of non-theremal soft tissue removal. Other additives can include solubilizing and emulsifying agents in modified embodiments when an object to be pursued is to solubilize and emulsify the fatty tissue being removed. All of the additives should preferably be biocompatale.

Corresponding or related structure and methods described in the following patents assigned to BIOLASE Technology, Inc., are incorporated herein by reference in their entireties, wherein such incorporation includes corresponding or related structure (and modifications thereof) in the following patents which may be, in whole or in part, (i) operable with, (ii) modified by one skilled in the art to be operable with, and/or (iii) implemented/used with or in combination with, any part(s) of the present invention according to this disclosure, that of the patents or below applications, and the knowledge and judgment of one skilled in the art:

| U.S. Pat. No. | Title |
|---|---|
| 7,356,208 | Fiber detector apparatus and related methods |
| 7,320,594 | Fluid and laser system |
| 7,303,397 | Caries detection using timing differentials between excitation and return |
| | pulses |
| 7,292,759 | Contra-angle rotating handpiece having tactile-feedback tip ferrule |
| 7,290,940 | Fiber tip detector apparatus and related methods |
| 7,288,086 | High-efficiency, side-pumped diode laser system |
| 7,270,657 | Radiation emitting apparatus with spatially controllable output energy |
| | distributions |
| 7,261,558 | Electromagnetic radiation emitting toothbrush and dentifrice system |
| 7,194,180 | Fiber detector apparatus and related methods |
| 7,187,822 | Fiber tip fluid output device |
| 7,144,249 | Device for dental care and whitening |
| 7,108,693 | Electromagnetic energy distributions for electromagnetically induced |
| | mechanical cutting |
| 7,068,912 | Fiber detector apparatus and related methods |
| 6,942,658 | Radiation emitting apparatus with spatially controllable output energy |
| | distributions |
| 6,829,427 | Fiber detector apparatus and related methods |
| 6,821,272 | Electromagnetic energy distributions for electromagnetically induced |
| | cutting |
| 6,744,790 | Device for reduction of thermal lensing |
| 6,669,685 | Tissue remover and method |
| 6,616,451 | Electromagnetic radiation emitting toothbrush and dentifrice system |
| 6,616,447 | Device for dental care and whitening |
| 6,610,053 | Methods of using atomized particles for electromagnetically induced |
| | cutting |
| 6,567,582 | Fiber tip fluid output device |
| 6,561,803 | Fluid conditioning system |
| 6,544,256 | Electromagnetically induced cutting with atomized fluid particles for |
| | dermatological applications |
| 6,533,775 | Light-activated hair treatment and removal device |
| 6,389,193 | Rotating handpiece |
| 6,350,123 | Fluid conditioning system |
| 6,288,499 | Electromagnetic energy distributions for electromagnetically induced |
| | mechanical cutting |
| 6,254,597 | Tissue remover and method |
| 6,231,567 | Material remover and method |
| 6,086,367 | Dental and medical procedures employing laser radiation |
| 5,968,037 | User programmable combination of atomized particles for |
| | electromagnetically induced cutting |
| 5,785,521 | Fluid conditioning system |
| 5,741,247 | Atomized fluid particles for electromagnetically induced cutting |

Also, the above disclosure and referenced items, and that described on the referenced pages, are intended to be operable or modifiable to be operable, in whole or in part, with corresponding or related structure and methods, in whole or in part, described in the following applications and items referenced therein, which applications include U.S. application Ser. No. 12/234,593, filed Sep. 19, 2008 and entitled PROBES AND BIOFLUIDS FOR TREATING AND REMOVING DEPOSITS FROM TISSUE SURFACES (Docket. BI8053P) and U.S. application Ser. No. 10/667,921, filed Sep. 22, 2003 and entitled TISSUE REMOVER AND METHOD (Docket. BI9100CIPCON), and which applications further include those listed as follows:

| U.S. Pub. App. No. | Title |
|---|---|
| 20080070185 | Caries detection using timing differentials between excitation and |
| | return pulses |
| 20080065057 | High-efficiency, side-pumped diode laser system |
| 20080065055 | Methods for treating eye conditions |
| 20080065054 | Methods for treating hyperopia and presbyopia via laser tunneling |
| 20080065053 | Methods for treating eye conditions |
| 20080033411 | High efficiency electromagnetic laser energy cutting device |
| 20080033409 | Methods for treating eye conditions |
| 20080033407 | Methods for treating eye conditions |
| 20080025675 | Fiber tip detector apparatus and related methods |
| 20080025672 | Contra-angle rotating handpiece having tactile-feedback tip ferrule |
| 20080025671 | Contra-angle rotating handpiece having tactile-feedback tip ferrule |
| 20070298369 | Electromagnetic radiation emitting toothbrush and dentifrice system |
| 20070263975 | Modified-output fiber optic tips |
| 20070258693 | Fiber detector apparatus and related methods |
| 20070208404 | Tissue treatment device and method |
| 20070208328 | Contra-angel rotating handpiece having tactile-feedback tip ferrule |
| 20070190482 | Fluid conditioning system |
| 20070184402 | Caries detection using real-time imaging and multiple excitation |
| | frequencies |
| 20070104419 | Fiber tip fluid output device |
| 20070060917 | High-efficiency, side-pumped diode laser system |
| 20070059660 | Device for dental care and whitening |
| 20070054236 | Device for dental care and whitening |
| 20070054235 | Device for dental care and whitening |
| 20070054233 | Device for dental care and whitening |
| 20070042315 | Visual feedback implements for electromagnetic energy output |
| | devices |
| 20070014517 | Electromagnetic energy emitting device with increased spot size |
| 20070014322 | Electromagnetic energy distributions for electromagnetically induced |
| | mechanical cutting |
| 20070009856 | Device having activated textured surfaces for treating oral tissue |
| 20070003604 | Tissue coverings bearing customized tissue images |
| 20060281042 | Electromagnetic radiation emitting toothbrush and dentifrice system |
| 20060275016 | Contra-angle rotating handpiece having tactile-feedback tip ferrule |
| 20060241574 | Electromagnetic energy distributions for electromagnetically induced |
| | disruptive cutting |
| 20060240381 | Fluid conditioning system |
| 20060210228 | Fiber detector apparatus and related methods |
| 20060204203 | Radiation emitting apparatus with spatially controllable output |
| | energy distributions |
| 20060142743 | Medical laser having controlled-temperature and sterilized fluid |
| | output |
| 20060099548 | Caries detection using timing differentials between excitation and |
| | return pulses |
| 20060043903 | Electromagnetic energy distributions for electromagnetically induced |
| | mechanical cutting |
| 20050283143 | Tissue remover and method |
| 20050281887 | Fluid conditioning system |
| 20050281530 | Modified-output fiber optic tips |
| 20040106082 | Device for dental care and whitening |
| 20040092925 | Methods of using atomized particles for electromagnetically induced |
| | cutting |
| 20040091834 | Electromagnetic radiation emitting toothbrush and dentifrice system |
| 20040068256 | Tissue remover and method |
| 20030228094 | Fiber tip fluid output device |
| 20020149324 | Electromagnetic energy distributions for electromagnetically induced |
| | mechanical cutting |
| 20020014855 | Electromagnetic energy distributions for electromagnetically induced |
| | mechanical cutting |

All of the contents of the preceding published applications are incorporated herein by reference in their entireties.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. As iterated above, any feature or combination of features described and referenced herein are included within the scope of the present invention provided that the features included in any such combination are not mutually inconsistent as will be apparent from the context, this specification, and the knowledge of one of ordinary skill in the art. For example, any of the energy outputs (e.g., lasers), any of the fluid outputs (e.g., water outputs), and any conditioning agents (incorporated by reference for use with the fluid(s)), particles, agents, etc., and particulars or features thereof, or other features, including method steps and techniques (disclosed or incorporated by reference), may be used with any other structure(s) and process described or referenced herein, in whole or in part, in any combination or permutation as a non-equivalent, separate, non-interchangeable aspect of this invention. Accordingly, the present invention is not intended to be limited by the disclosed embodiments, but is to be defined by such embodiments and by reference to the following claims.

What is claimed is:

1. An endodontic probe having an elongate body sized to fit within a root canal passage, the elongate body including a body proximal region, a body distal region and a body longitudinal axis extending between the body proximal region and the body distal region, the endodontic probe comprising:
(a) an electromagnetic radiation emitting fiber optic tip disposed at the body distal region, the fiber optic tip having a distal end and a radiation emitting region disposed proximally of the distal end, the radiation emitting region being structured to emit a peak concentration of radiation along a line that is not parallel to the body longitudinal axis; and
(b) a porous structure characterized by one or more of (i) encompassing a region of the fiber optic tip excluding the radiation emitting region and (ii) comprising a material that is transparent to a wavelength of energy carried by the electromagnetic radiation emitting fiber optic tip, the porous structure comprising pores that are loaded with a biofluid or biopowder, the biofluid or biopowder comprising one or more of biologically-active particles, cleaning particles, biologically-active agents, and cleaning agents that are structured to be delivered from the porous structure onto tissue.

2. The endodontic probe as set forth in claim 1, wherein the porous structure is a porous wall which is an integral, non-removable part of the fiber optic tip.

3. The endodontic probe as set forth in claim 1, wherein the porous structure covers a region of the fiber optic tip distally of the radiation emitting region.

4. The endodontic probe as set forth in claim 1, wherein the porous structure is secured to and can be retracted and removed from the endodontic probe while inside of a dentinal canal.

5. The endodontic probe as set forth in claim 1, wherein the electromagnetic radiation emitting fiber optic tip is coupled to one or more of an infrared laser and a near-infrared laser.

6. The endodontic probe as set forth in claim 1, wherein the radiation emitting region is structured to emit a greater concentration in a non-distal direction than in a distal direction.

7. The endodontic probe as set forth in claim 1, wherein the radiation emitting region comprises a longitudinal axis and is structured to emit a peak concentration of radiation along a line that is not parallel to the longitudinal axis.

8. The endodontic probe as set forth in claim 1, wherein the particles or agents comprise cleaning particles.

9. The endodontic probe as set forth in claim 1, wherein the particles or agents comprise anesthetizing particles.

10. The endodontic probe as set forth in claim 1, wherein the particles or agents comprise disinfectant particles.

11. The endodontic probe as set forth in claim 1, wherein the particles or agents are suspended in a liquid.

12. The endodontic probe as set forth in claim 1, wherein liquid has a viscosity greater than that of water.

13. The endodontic probe as set forth in claim 1, wherein the porous structure comprises a sheath.

14. The endodontic probe as set forth in claim 1, wherein the porous structure comprises a fabric

15. The endodontic probe as set forth in claim 1, wherein the porous structure comprises a sponge.

16. The endodontic probe as set forth in claim 1, wherein the porous structure comprises a membrane disposed around at least a part of the electromagnetic radiation emitting fiber optic tip.

17. The endodontic probe as set forth in claim 1, and further comprising a fluid output.

18. The endodontic probe as set forth in claim 1, a portion of the electromagnetic radiation emitting fiber optic tip disposed proximally of the distal end comprising a jacket, and the distal end not comprising the jacket.

19. The endodontic probe as set forth in claim 1, the porous structure comprising a sponge or sheath formed in a compact, low-profile fashion for providing minimally invasive access to a surgical site of tissue comprising one or more of a canal, a pocket, and a periodontal pocket.

20. The endodontic probe as set forth in claim 1, the porous structure comprising a sponge or sheath formed to expand and allow the release of biofluids or biopowders to a target site upon placement into contact with a fluid in a mouth.
